(19) United States
(12) Patent Application Publication
(10) Pub. No.: US 2018/0359662 A1
(43) Pub. Date: Dec. 13, 2018

(54) METHOD FOR TRANSMITTING AND RECEIVING SIGNAL RELATED TO DATA-OFF FUNCTION

(71) Applicant: LG ELECTRONICS INC., Seoul (KR)

(72) Inventors: Laeyoung KIM, Seoul (KR); Sungduck CHUN, Seoul (KR); Hyunsook KIM, Seoul (KR); Jaehyun KIM, Seoul (KR); Taehun KIM, Seoul (KR)

(21) Appl. No.: 15/780,894

(22) PCT Filed: Dec. 5, 2016
(86) PCT No.: PCT/KR2016/014178

§ 371 Date: Jun. 1, 2018

Related U.S. Application Data
(60) Provisional application No. 62/262,875, filed on Dec. 3, 2015.
(60) Provisional application No. 62/269,113, filed on Dec. 18, 2015.
(60) Provisional application No. 62/270,023, filed on Dec. 20, 2015.
(60) Provisional application No. 62/287,447, filed on Jan. 27, 2016.

(51) Int. Cl. H04W 36/00; H04L 29/06; H04W 8/04; H04W 80/10

(52) U.S. Cl. CPC H04W 36/0022; H04L 65/1006; H04W 80/10; H04L 65/102; H04W 8/04; H04L 65/1016

(57) ABSTRACT

One embodiment of the present invention relates to a method for transmitting and receiving a signal related to a data-off function of a user equipment (UE) in a wireless communication system, comprising the steps of: transmitting, to an IP multimedia system (IMS) node, a session initiation protocol (SIP) register message including activation information of the data-off function wherein, when the data-off function is activated, the UE receives only a SIP message corresponding to data-off exempt services from the IMS node; and receiving a response message as a response to the SIP message.

### TECHNICAL FIELD

The present invention relates to a wireless communication system, and more particularly, to a method of transmitting and receiving a signal related to a data-off function.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.) among them. For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi-Carrier Frequency Division Multiple Access (MC-F-DMA) system.

With appearance and spread of machine-to-machine (M2M) communication and a variety of devices such as smartphones and tablet PCs and technology demanding a large amount of data transmission, data throughput needed in a cellular network has rapidly increased. To satisfy such rapidly increasing data throughput, carrier aggregation technology, cognitive radio technology, etc. for efficiently employing more frequency bands and multiple input multiple output (MIMO) technology, multi-base station (BS) cooperation technology, etc. for raising data capacity transmitted on limited frequency resources have been developed.

In addition, a communication environment has evolved into increasing density of nodes accessible by a user equipment (UE) at the periphery of the nodes. A node refers to a fixed point capable of transmitting/receiving a radio signal to/from a UE through one or more antennas. A communication system equipped with high-density nodes may provide a better communication service to the UE through cooperation between the nodes.

### DISCLOSURE OF THE INVENTION

### Technical Task

A technical task of the present invention is to provide a communication system capable of providing a minimum service to a user and blocking unnecessarily generated data use by permitting a data flow for a service mandatorily supported to the user and blocking other data flow when the user configures the use of mobile data to be turned off in a UE of the user and a method of controlling therefor.

Technical tasks obtainable from the present invention are non-limited by the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of transmitting and receiving a signal related to a DataOff function of a UE (user equipment) in a wireless communication system, includes the steps of transmitting an SIP (Session Initiation Protocol) register message including activation information of the DataOff function to an IMS (IP Multimedia Subsystem) node, wherein if the DataOff function is activated, the UE receives only an SIP message corresponding to DataOff Exempt Services from the IMS node, and receiving a response message in response to the SIP register message.

To further achieve these and other advantages and in accordance with the purpose of the present invention, according to a different embodiment, a UE (user equipment) transmitting and receiving a signal related to a DataOff function in a wireless communication system includes a transceiver and a processor, the processor configured to transmit an SIP register message including activation information of the DataOff function to an IMS node, wherein if the DataOff function is activated, the UE receives only an SIP message corresponding to DataOff Exempt Services from the IMS node, the processor configured to receive a response message in response to the SIP register message.

The IMS node may correspond to an S-CSCF (Serving Call State Control Function).

The activation information of the DataOff function can be transmitted even when a PDN (Packet Data Network) connection is requested.

The activation information of the DataOff function can be included in PCO (Protocol Configuration Options).

Whether or not the SIP message corresponds to the DataOff Exempt Services can be determined by Filter Criteria obtained from an HSS (Home Subscriber Server).

If the DataOff function is not activated, the UE can receive the SIP message irrespective of the Data Exempt Services.

The UE may correspond to a UE supporting PS (Packet Switch) only or a UE which has accessed a network supporting the PS only.

The UE may correspond to a user in a roaming state.

### Advantageous Effects

According to the present invention, it is able to efficiently use a radio resource by transmitting data associated with an essential service only in a radio section of a mobile communication network. By doing so, it is able to increase overall throughput of a wireless communication system.

According to the present invention, although a general internet access function is turned off, an essential communication service is provided. Hence, it is able to efficiently support a data-off function.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating a schematic structure of an EPS (evolved packet system) including an EPC (evolved packet core);

FIG. 2 is a diagram illustrating architectures of a general E-UTRAN and an EPC;

FIG. 3 is a diagram illustrating a structure of a radio interface protocol in a control plane;

FIG. 4 is a diagram illustrating a structure of a radio interface protocol in a user plane;

FIG. 5 is a flowchart illustrating an initial attach procedure of a system;

FIG. 6 is a flowchart illustrating a UE triggered service request procedure;

FIG. 7 is a flowchart illustrating a tracking area update (TAU) procedure;

FIG. 8 is a flowchart illustrating an IMS register procedure;

FIG. 9 is a diagram for explaining initial filter criteria (IFC);

FIG. 10 is a diagram for explaining a service point trigger;

FIG. 11 is a diagram for explaining an application triggering structure;

FIG. 12 is a diagram illustrating an example of IFC triggering;

FIG. 13 is a flowchart illustrating a data-off function according to the present invention with reference to an attach procedure;

FIG. 14 is a flowchart for an IP-CAN session establishment procedure according to one embodiment of the present invention;

FIG. 15 is a flowchart for an IP-CAN session modification procedure according to one embodiment of the present invention;

FIG. 16 is a flowchart for an IP-CAN session modification procedure initiated by a PCRF according to one embodiment of the present invention;

FIG. 17 is a diagram illustrating traffic steering according to one embodiment of the present invention;

FIG. 18 is a diagram for a configuration of a node device applied to the proposal of the present invention.

### BEST MODE

### Mode for Invention

Although the terms used in the present invention are selected from generally known and used terms, terms used herein may be varied depending on operator's intention or customs in the art, appearance of new technology, or the like. In addition, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

The following embodiments are proposed by combining constituent components and characteristics of the present invention according to a predetermined format. The individual constituent components or characteristics should be considered optional factors on the condition that there is no additional remark. If required, the individual constituent components or characteristics may not be combined with other components or characteristics. In addition, some constituent components and/or characteristics may be combined to implement the embodiments of the present invention. The order of operations to be disclosed in the embodiments of the present invention may be changed. Some components or characteristics of any embodiment may also be included in other embodiments, or may be replaced with those of the other embodiments as necessary.

In describing the present invention, if it is determined that the detailed description of a related known function or construction renders the scope of the present invention unnecessarily ambiguous, the detailed description thereof will be omitted.

In the entire specification, when a certain portion “comprises or includes” a certain component, this indicates that the other components are not excluded and may be further included unless specially described otherwise. The terms “unit”, “-or/er” and “module” described in the specification indicate a unit for processing at least one function or operation, which may be implemented by hardware, software or a combination thereof. The words “a or an”, “one”, “the” and words related thereto may be used to include both a singular expression and a plural expression unless the context describing the present invention (particularly, the context of the following claims) clearly indicates otherwise.

The embodiments of the present invention can be supported by standard documents disclosed for at least one of wireless access systems, Institute of Electrical and Electronics Engineers (IEEE) 802, 3rd Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents.

In addition, all the terms disclosed in the present document may be described by the above standard documents. Technologies and terms, which are mentioned in the present invention but not explained, can be supported by at least one or more standard documents of 3GPP TS 36.321, TS 36.322, 3GPP TS 36.323, 3GPP TS 36.331, 3GPP TS 23.401, 3GPP TS 24.301, 3GPP TS 23.228, 3GPP TS 29.228, 3GPP TS 23. 218, 3GPP TS 22.011, and 3GPP TS 36.413.

Hereinafter, the preferred embodiments of the present invention will be described with reference to the accompanying drawings. It is to be understood that the detailed description which will be disclosed along with the accompanying drawings is intended to describe the exemplary embodiments of the present invention, and is not intended to describe a unique embodiment which the present invention can be carried out.

It should be noted that specific terms disclosed in the present invention are proposed for convenience of description and better understanding of the present invention, and the use of these specific terms may be changed to another format within the technical scope or spirit of the present invention.

First of all, the terms used in the present specification can be defined as follows.
IMS (IP Multimedia Subsystem or IP Multimedia Core Network Subsystem): an architectural framework for providing standardization to deliver voice or other multimedia service on IP
SIP (Session Initiation Protocol): IETF (Internet Engineering Task Force) standard protocol for initiating an interactive user session involving multimedia elements such as video, audio, chatting, game, VR, etc. Similar to HTTP or SMTP, the SIP operates on an application layer of OSI (Open Systems Interconnection) communication model. The SIP can establish, modify or terminate a multimedia session or internet telephone call.
UMTS (Universal Mobile Telecommunications System): a GSM (Global System for Mobile Communication) based third generation mobile communication technology developed by the 3GPP.
EPS (Evolved Packet System): a network system that includes an EPC (Evolved Packet Core) which is an IP (Internet Protocol) based packet switched core network and an access network such as LTE and UTRAN. This system is the network of an evolved version of the UMTS.
NodeB: a base station of GERAN/UTRAN. This base station is installed outdoor and its coverage has a scale of a macro cell.
eNodeB: a base station of LTE. This base station is installed outdoor and its coverage has a scale of a macro cell.
UE (User Equipment): the UE may be referred to as terminal, ME (Mobile Equipment), MS (Mobile Station), etc. Also, the UE may correspond to a portable device such as a notebook computer, a cellular phone, a PDA (Personal Digital Assistant), a smartphone, and a multimedia device. Alternatively, the UE may correspond to a non-portable device such as a PC (Personal Computer) and a vehicle mounted device. The term “UE”, as used in relation to MTC, may refer to an MTC device.
HNB (Home NodeB): a base station of UMTS network. This base station is installed indoor and its coverage has a scale of a micro cell.
HeNB (Home eNodeB): a base station of an EPS network. This base station is installed indoor and its coverage has a scale of a micro cell.
MME (Mobility Management Entity): a network node of an EPS network, which performs mobility management (MM) and session management (SM).
PDN-GW (Packet Data Network-Gateway)/PGW: a network node of an EPS network, which performs UE IP address allocation, packet screening and filtering, charging data collection, etc.
SGW (Serving Gateway): a network node of an EPS network, which performs mobility anchor, packet routing, idle-mode packet buffering, and triggering of an MME's UE paging.
PCRF (Policy and Charging Rule Function): a network node of EPS network that performs policy decision to dynamically apply a differentiated QoS and a charging policy according to a service flow.
OMA DM (Open Mobile Alliance Device Management): a protocol designed to manage mobile devices such as a cellular phone, a PDA, a portable PC, and the like. The OMA DM performs such a function as device configuration. firmware upgrade, error report, and the like.
OAM (Operation Administration and Maintenance): a network management function group that provides such a function as network defect display, performance information, and a data diagnosis function.
NAS (Non-Access Stratum): an upper stratum of a control plane between a UE and an MME. This is a functional layer for transmitting and receiving a signaling and traffic message between a UE and a core network in an LTE/UMTS protocol stack, and supports mobility of a UE, and supports a session management procedure of establishing and maintaining IP connection between a UE and a PDN GW.
EMM (EPS Mobility Management): a sublayer of a NAS layer. The EMM may be in ‘EMM-Registered’ or ‘EMM-Deregistered’ state depending on whether a UE is attached/detached to/from a network.
ECM (EMM Connection Management) connection: a signaling connection established between a UE and an MME to exchange a NAS message. The ECM connection corresponds to a logical connection configured by an RRC connection between a UE and an eNB and an S1 signaling connection between the eNB and the MME. If the ECM connection is established/terminated, the RRC connection and the S1 connection are also established/terminated. If the ECM connection is established, it means that a UE has an RRC connection established with the eNB. And, it means that the MME has an S1 signaling connection established with the eNB. The ECM may have ‘ECM-Connected’ or ‘ECM-Idel’ state depending on whether or not NAS signaling connection, i.e., ECM connection, is established.
AS (Access-Stratum): a protocol stack between a UE and a wireless (or access) network. The AS is in charge of transmitting data and a network control signal.
NAS configuration MO (Management Object): MO (Management Object) used for setting parameters associated with a NAS functionality to a UE.
PDN (Packet Data Network): a network in which a server supporting a specific service (e.g., a Multimedia Messaging Service (MMS) server, a Wireless Application Protocol (WAP) server, etc.) is located.
PDN connection: a logical connection between a UE and a PDN represented by one IP address (one IPv4 address and/or one IPv6 prefix).
APN (Access Point Name): a character string for indicating a PDN. In order to access a requested service or a network, it is necessary to pass through a specific P-GW. The APN corresponds to a name (character string) predefined in a network to discover the P-GW. (e.g., internet.mnc012.mcc345.gprs)
RAN (Radio Access Network): a unit including a Node B, an eNode B, and a Radio Network Controller (RNC) for controlling the Node B and the eNode B in a 3GPP network, which is present between UEs and provides a connection to a core network.
HLR (Home Location Register)/HSS (Home Subscriber Server): a database having subscriber information in a 3GPP network. The HSS can perform functions such as configuration storage, identity management, and user state storage.
PLMN (Public Land Mobile Network): a network configured for the purpose of providing mobile communication services to individuals. This network can be configured per operator.
ANDSF (Access Network Discovery and Selection Function): corresponds to a network entity and provides a policy to make a UE discover and select available access in a unit of a service provider.
EPC path (or infrastructure data path): a user plane communication path through EPC
E-RAB (E-UTRAN Radio Access Bearer): corresponds to concatenation between S1 bearer and a corresponding data wireless bearer. If E-RAB exists, the E-RAB and EPS bearer of NAS are mapped by one-to-one.
GTP (GPRS Tunneling Protocol): a group of IP-based communication protocols for carrying a general packet radio service (GPRS) in GSM, UMTS, and LTE network. GTP and proxy mobile IPv6-based interfaces are specified on various interface points in 3GPP architecture. The GTP can be decomposed into several protocols (e.g., GTP-C, GTP-U, and GTP'). The GTP-C is used in a GPRS core network to perform signaling between gateway GPRS supporting nodes (GGSN) and serving GPRS supporting nodes (SGSN). The GTP-C allows the SGSN to activate a session for a user (e.g., activate PDN context), deactivate the same session, adjust quality of service parameters, or update a session for a subscriber immediately operated from a different SGSN. The GTP-U is used to carry a user data in the GPRS core network and between a wireless access network and a core network. The GTP′ (GTP prime) uses a message structure identical to a message structure used by the GTP-C while having an independent function. For example, the GTP′ can be used to carry charging data ranging from a charging data function (CDF) to a charging gateway function (CGF) of the GSM or the UMTS network.

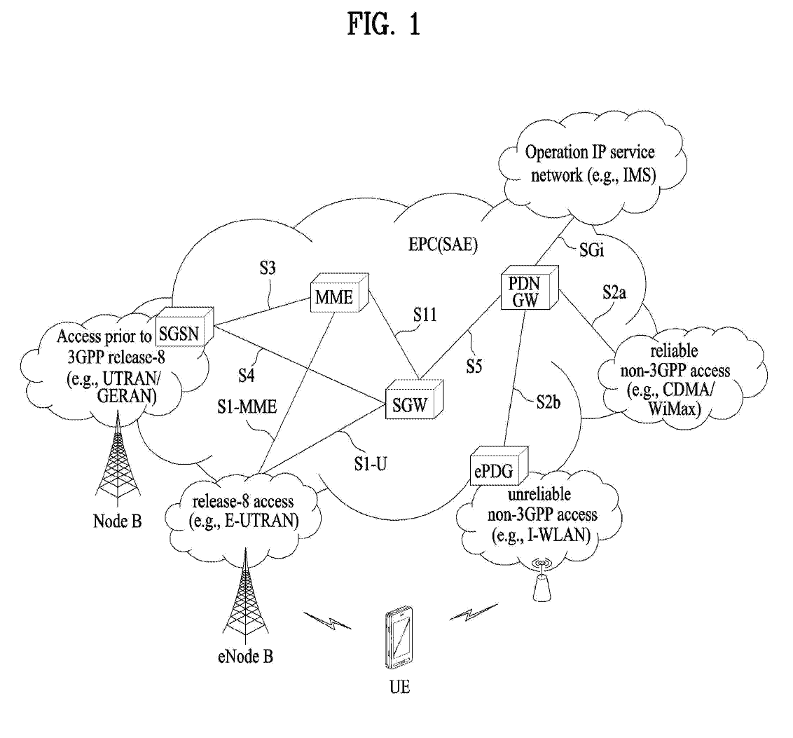

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, In 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

The SGW operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point can be used intra-PLMN or |
| | inter-PLMN (e.g. in the case of Inter-PLMN HO). |
| S4 | It provides related control and mobility support between GPRS Core and the 3GPP |
| | Anchor function of Serving GW. In addition, if Direct Tunnel is not established, it |
| | provides the user plane tunneling. |
| S5 | It provides user plane tunneling and tunnel management between Serving GW and |
| | PDN GW. It is used for Serving GW relocation due to UE mobility and if the |
| | Serving GW needs to connect to a non-collocated PDN GW for the required PDN |
| | connectivity. |
| S11 | Reference point between an MME and an SGW |
| SGi | It is the reference point between the PDN GW and the packet data network. Packet |
| | data network may be an operator external public or private packet data network or |
| | an intra operator packet data network, e.g. for provision of IMS services. This |
| | reference point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

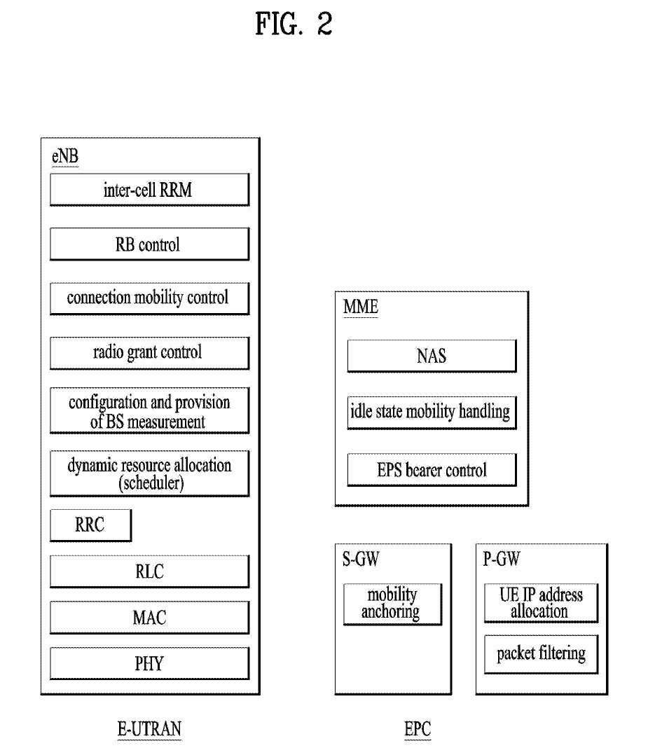

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE_IDLE state management, ciphering of the user plane, SAE bearer control, and ciphering and integrity protection of NAS signaling.

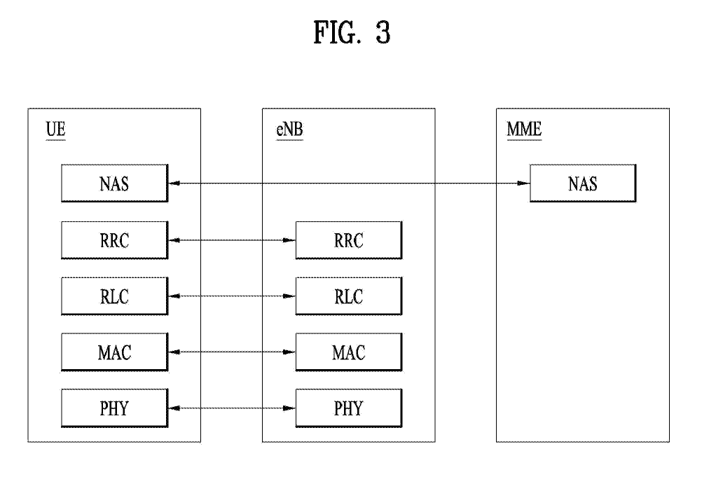

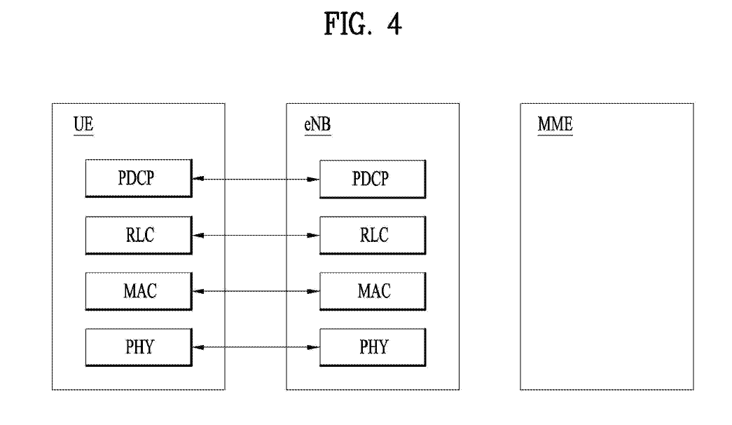

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel The physical channel layer is connected to a medium access control (MAC) layer, which is a higher layer of the physical layer, through a transport channel Data is transferred between the physical layer and the MAC layer through the transport channel Transfer of data between different physical layers, i.e., a physical layer of a transmitter and a physical layer of a receiver is performed through the physical channel

The physical channel consists of a plurality of subframes in the time domain and a plurality of subcarriers in the frequency domain. One subframe consists of a plurality of symbols in the time domain and a plurality of subcarriers. One subframe consists of a plurality of resource blocks. One resource block consists of a plurality of symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers. First, the MAC layer in the second layer serves to map various logical channels to various transport channels and also serves to map various logical channels to one transport channel. The MAC layer is connected with an RLC layer, which is a higher layer, through a logical channel The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The eSM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one ID. This ID is called an EPS bearer ID. One EPS bearer has QoS characteristics of a maximum bit rate (MBR) and/or a guaranteed bit rate (GBR).

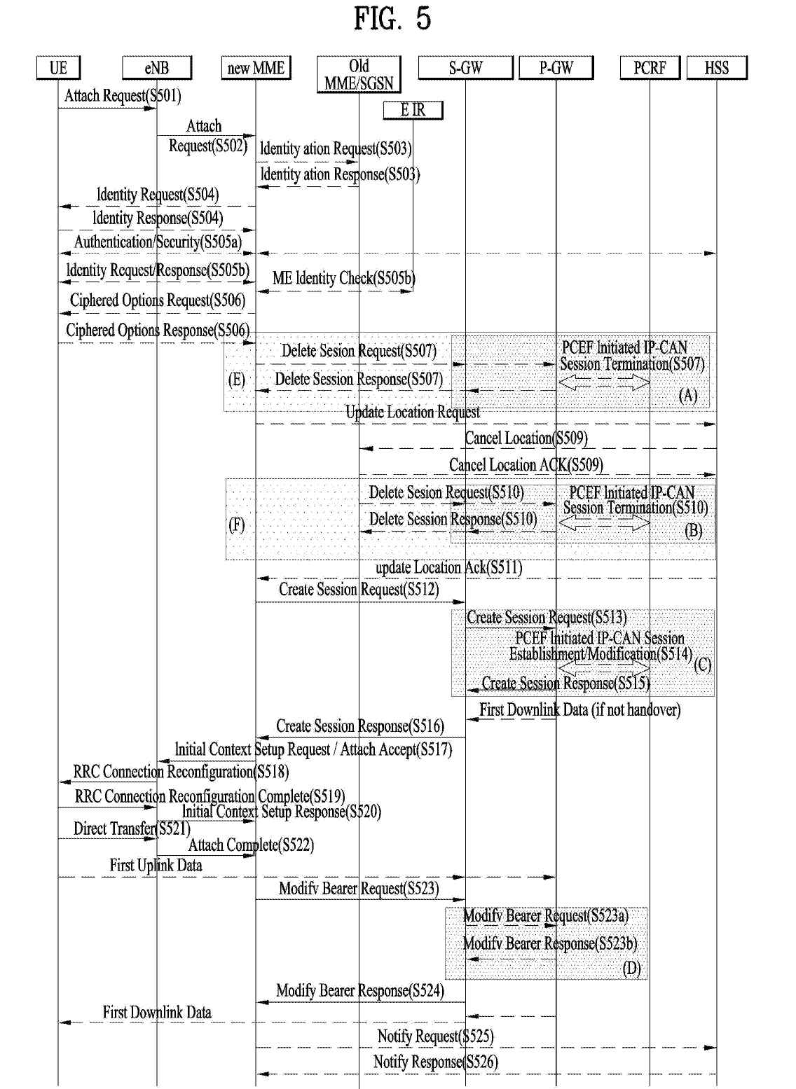

FIG. 5 is a flowchart illustrating an initial attach procedure.

A UE/user needs to register with the network to receive services that require registration. This registration is described as Network Attachment. The always-on IP connectivity for a UE of the EPS is enabled by establishing a default EPS bearer during Network Attachment. The PCC (Policy and Charging Control) rules applied to the default EPS bearer may be predefined in the PDN GW and activated in the attachment by the PDN GW itself. The Attach procedure may trigger one or multiple Dedicated Bearer Establishment procedures to establish dedicated EPS bearer(s) for that UE. During the attach procedure, the UE may request for an IP address allocation. Terminals utilizing only IETF (Internet Engineering Task Force)-based mechanisms for IP address allocation are also supported.

During the Initial Attach procedure, the Mobile Equipment (ME) identity is obtained from the UE. The MME operator may check the ME identity with an EIR (Equipment Identity Register). At least in roaming situations, the MME should pass the ME identity to the HSS, and, if a PDN-GW is outside of the VPLMN (visited PLMN), should pass the ME identity to the PDN-GW.

A system initial attach procedure is explained with reference to FIG. 5.

S501. The UE initiates the Attach procedure by the transmission, to the eNB, of an Attach Request message together with the old GUMMEI (Globally Unique Mobility management Entity Identifier).

S502. The eNB derives the MME from the old GUMMEI value, the RRC parameters and the indicated Selected Network information. If that MME is not associated with the eNB or the old GUMMEI is not available, the eNB directly selects an MME. The eNB forwards the Attach Request message to the new MME contained in an S1-MME control message (Initial UE message).

S503. If the UE identifies itself with GUTI (Globally Unique Temporary Identity) and the MME has changed since detach, the new MME uses the GUTI received from the UE to derive the old MME/SGSN address, and send an Identification Request to the old MME/SGSN to request the IMSI (International Mobile Subscriber Identity). If the request is sent to an old MME, the old MME first verifies the Attach Request message by NAS MAC and then responds with Identification Response. If the request is sent to an old SGSN, the old SGSN first verifies the Attach Request message by the P-TMSI signature and then responds with Identification Response.

S504. If the UE is unknown in both the old MME/SGSN and new MME, the new MME sends an Identity Request to the UE to request the IMSI. The UE responds with Identity Response.

S505a. If no UE context for the UE exists anywhere in the network, if the Attach Request (sent in step 1) was not integrity protected, or if the check of the integrity failed, then authentication and NAS security setup to activate integrity protection and NAS ciphering are mandatory. Otherwise, it is optional. If NAS security algorithm is to be changed, the NAS security setup is performed in this step.

S505b. The ME Identity delivered to the UE from the UE. The ME identity is delivered in a manner of being encrypted.

S506. If the UE has set the Ciphered Options Transfer Flag in the Attach Request message, the Ciphered Options shall now be retrieved from the UE.

S507. If there are active bearer contexts in the new MME for this particular UE (i.e. the UE re-attaches to the same MME without having properly detached before), the new MME deletes these bearer contexts by sending Delete Session Request (TEIDs) messages to the GWs involved. The GWs acknowledge with Delete Session Response (TEIDs) message. If a PCRF is deployed, the PDN GW employs an IP-CAN Session Termination procedure to indicate that resources have been released.

S508. If the MME has changed since the last detach, or if there is no valid subscription context for the UE in the MME, or if the ME identity has changed, or if the UE provides an IMSI or the UE provides an old GUTI which doesn't refer to a valid context in the MME, the MME sends an Update Location Request message to the HSS (Home Subscriber Server).

S509. The HSS sends Cancel Location to the old MME. The old MME acknowledges with Cancel Location Ack and removes the MM (Mobility Management) and bearer contexts.

S510. If there are active bearer contexts in the old MME/SGSN for this particular UE, the old MME/SGSN deletes these bearer contexts by sending Delete Session Request (TEIDs) messages to the GWs involved. The GWs return Delete Session Response message to the old MME/SGSN. If a PCRF is deployed, the PDN GW employs an IP-CAN Session Termination procedure to indicate that resources have been released.

S511. The HSS acknowledges the Update Location message by sending an Update Location Ack (IMSI, Subscription data) message to the new MME. The Subscription Data contain one or more PDN subscription contexts. The new MME validates the UE's presence in the (new) TA (tracking area). If due to regional subscription restrictions or access restrictions the UE is not allowed to attach in the TA or due to subscription checking fails for other reasons, the new MME rejects the Attach Request with an appropriate cause. If all checks are successful then the new MME constructs a context for the UE. If the APN provided by the UE is not allowed by subscription, or the Update Location is rejected by the HSS, the new MME rejects the Attach Request from the UE with an appropriate cause.

S512. If a subscribed PDN address is allocated for the UE for this APN, the PDN subscription context contains the UE's IPv4 address and/or the IPv6 prefix and optionally the PDN GW identity. If the PDN subscription context contains a subscribed IPv4 address and/or IPv6 prefix, the MME indicates it in the PDN address. The new MME selects a Serving GW and allocates an EPS Bearer Identity for the Default Bearer associated with the UE. Then it sends a Create Session Request message to the selected Serving GW.

S513. The Serving GW creates a new entry in its EPS Bearer table and sends a Create Session Request message to the PDN GW indicated by the PDN GW address received in the previous step.

S514. If dynamic PCC is deployed and the Handover Indication is not present, the PDN GW performs an IP-CAN Session Establishment procedure and thereby obtains the default PCC rules for the UE.

The IMSI, UE IP address, User Location Information (ECGI), Serving Network, RAT type, APN-AMBR, Default EPS Bearer QoS are provided to the PCRF by the PDN GW if received by the previous message.

The PCRF may modify the APN-AMBR and the QoS parameters (QCI and ARP) associated with the default bearer in the response to the PDN

If the IP address is not available when the PDN GW performs the IP-CAN Session Establishment procedure with the PCRF, the PDN GW initiates an IP-CAN Session Modification procedure to inform the PCRF about an allocated IP address as soon as the address is available.

If dynamic PCC is deployed and the Handover Indication is present, the PDN GW executes a PCEF Initiated IP-CAN Session Modification procedure with the PCRF to report the new IP-CAN type.

S515. The P-GW creates a new entry in its EPS bearer context table and generates a Charging Id. The new entry allows the P-GW to route user plane PDUs between the S-GW and the packet data network, and to start charging.

The PDN GW returns a Create Session Response message to the Serving GW.

S516. The Serving GW returns a Create Session Response message to the new MME.

S517. The new MME sends an Attach Accept message to the eNB.

S518. The eNB sends the RRC Connection Reconfiguration message including the EPS Radio Bearer Identity to the UE, and the Attach Accept message will be sent along to the UE.

S519. The UE sends the RRC Connection Reconfiguration Complete message to the eNB.

S520. The eNB sends the Initial Context Response message to the new MME.

S521. The UE sends a Direct Transfer message to the eNB, which includes the Attach Complete message.

S522. The eNB forwards the Attach Complete message to the new MME in an Uplink NAS Transport message.

S523. Upon reception of both, the Initial Context Response message in the step S521 and the Attach Complete message in the step S522, the new MME sends a Modify Bearer Request message to the Serving GW.

S523a. If the Handover Indication is included in the step S523, the Serving GW sends a Modify Bearer Request (Handover Indication) message to the PDN GW to prompt the PDN GW to tunnel packets from non 3GPP IP access to 3GPP access system and immediately start routing packets to the Serving GW for the default and any dedicated EPS bearers established.

S523b. The PDN GW acknowledges by sending Modify Bearer Response to the Serving GW.

S524. The Serving GW acknowledges by sending Modify Bearer Response (EPS Bearer Identity) message to the new MME.

S525. After the MME receives Modify Bearer Response message, if Request type does not indicate handover and an EPS bearer was established and the subscription data indicates that the user is allowed to perform handover to non-3GPP accesses, and if the MME selected a PDN GW that is different from the PDN GW identity which was indicated by the HSS in the PDN subscription context, the MME shall send a Notify Request including the APN and PDN GW identity to the HSS for mobility with non-3GPP accesses. The message shall also include information that identifies the PLMN in which the PDN GW is located.

S526. The HSS stores the APN and PDN GW identity pair and sends a Notify Response to the MME.

If new traffic occurs, in order for a UE in an idle state to switch to an activated state capable of transmitting and receiving traffic, a service request procedure is performed. In a state that a UE is registered at a network, S1 connection is released due to traffic deactivation, and a radio resource is not allocated, in particular, when the UE is in EMM register state (EMM-Registered) but in ECM idle state (ECM-idle), if traffic to be transmitted by the UE occurs or traffic to be transmitted to the UE occurs in a network, the UE requests a service to the network to switch to ECM connected state (ECM-Connected) and transmits/receives the traffic by configuring ECM connection (RRC connection+S1 signaling connection) in a control plane and configuring E-RAB (DRB and S1 bearer) in a user plane. If the network has traffic to be transmitted to the UE, the network informs the UE of the traffic in advance to make the UE request a service.

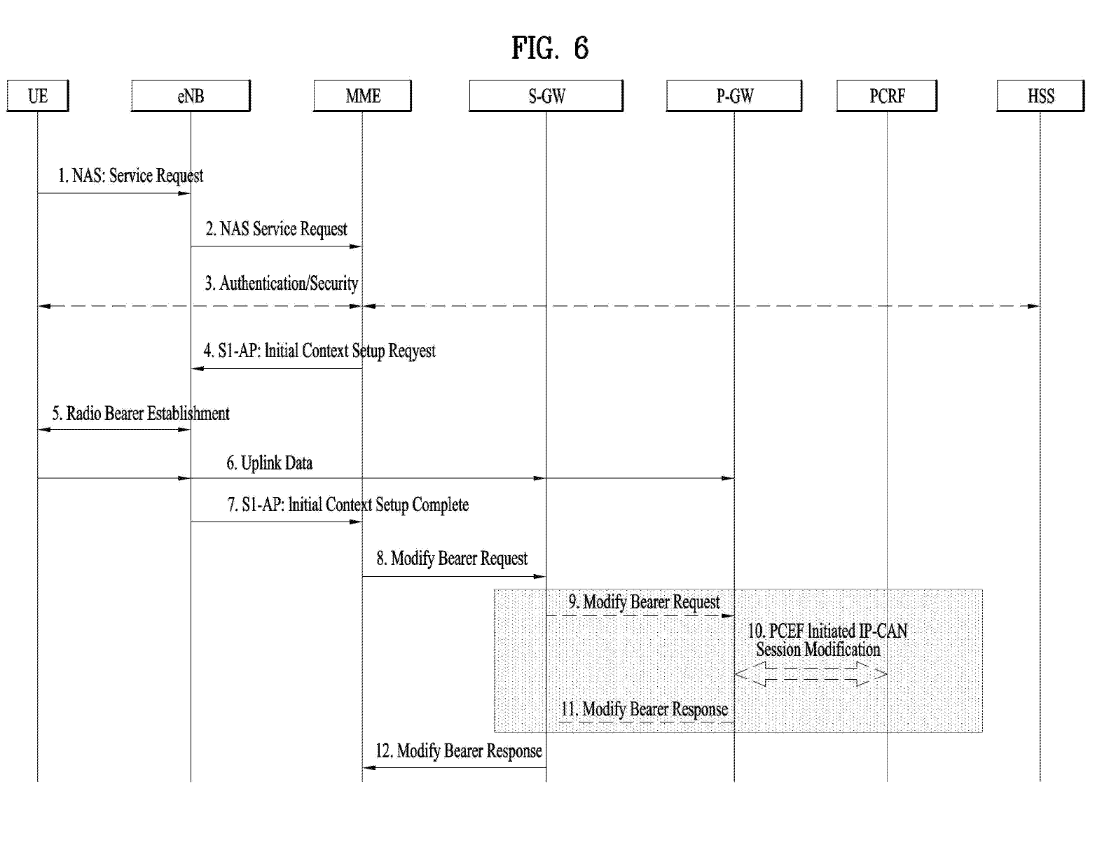

FIG. 6 is a flowchart illustrating a UE triggered service request procedure.

For a service request procedure, it may refer to 3GPP TS 23.401 document (e.g., 3GPP TS 23.401 v13.4.0 section 5.3.4). Detail explanation on the service request procedure is omitted. In particular, for a UE triggered service request procedure, it may refer to 3GPP TS 23.401 v13.4.0 section 5.3.4.1.

Meanwhile, in order for a network (e.g., MME) to know a tracking area (TA) at which a specific UE is located, the network should update location information on idle UEs. To this end, whenever a UE moves between TAs, the UE transmits a TAU request message to the network to notify a current position of the UE to the network.

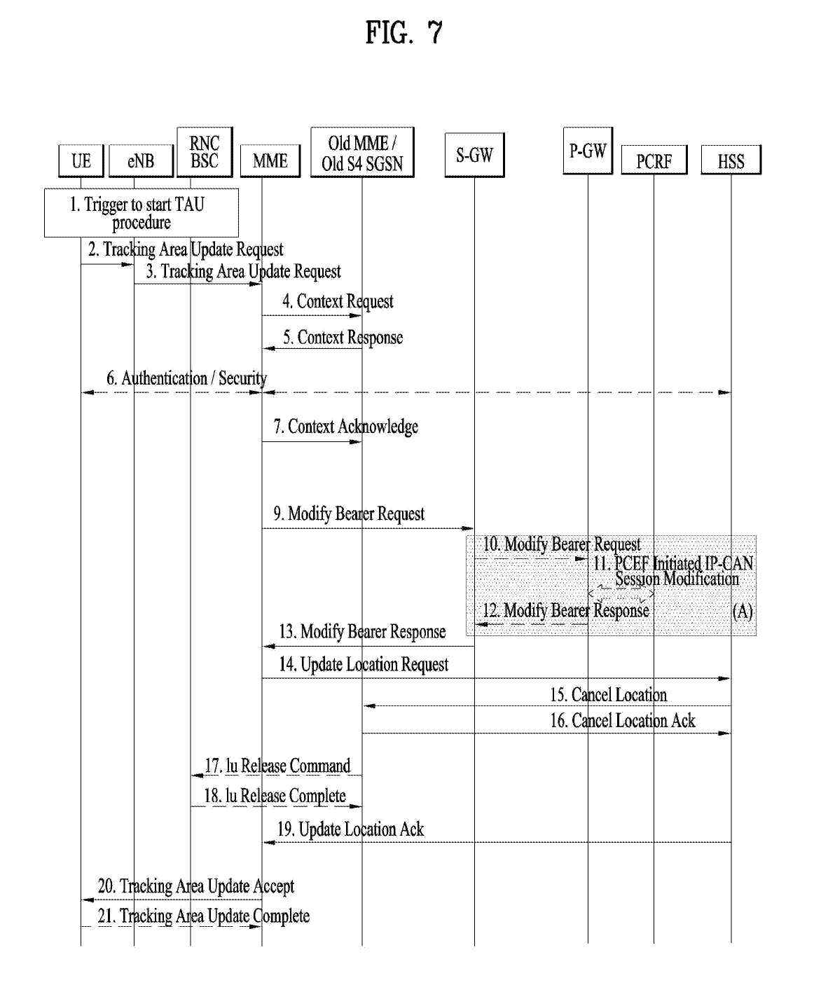

FIG. 7 is a flowchart illustrating a tracking area update (TAU) procedure.

For the TAU procedure, it may refer to 3GPP TS 23.401 document (e.g., 3GPP TS 23.401 v13.4.0 document section 5.3.3). Detail explanation on the TAU procedure is omitted.

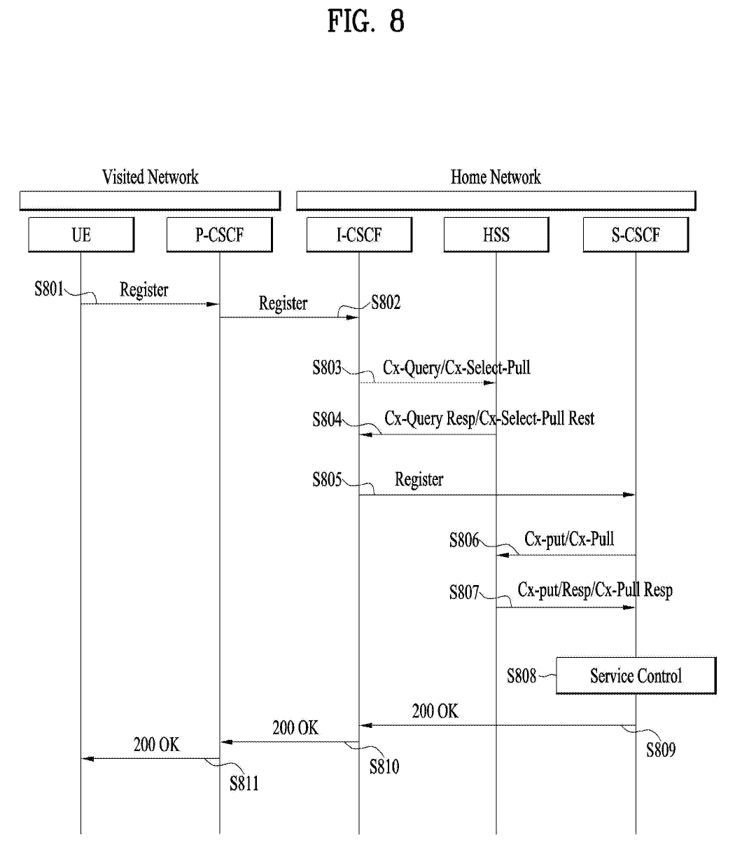

FIG. 8 is a flowchart illustrating an IMS register procedure.

Referring to FIG. 8, in the step S801, after the UE has obtained IP connectivity, it can perform the IM registration. To do so, the UE sends the Register information flow (Public User Identity, Private User Identity, home network domain name, UE IP address, Instance Identifier, GRUU Support Indication) to the proxy (i.e., P-CSCF).

In the step S802, upon receipt of the register information flow, the P-CSCF shall examine the “home domain name” to discover the entry point to the home network (i.e. the I-CSCF). The proxy shall send the Register information flow to the I-CSCF (P-CSCF address/name, Public User Identity, Private User Identity, P-CSCF network identifier, UE IP address). A name-address resolution mechanism is utilized in order to determine the address of the home network from the home domain name. The P-CSCF network identifier is a string that identifies at the home network, the network where the P-CSCF is located (e.g., the P-CSCF network identifier may correspond to the domain name of the P-CSCF network).

In the step S803, the I-CSCF shall send the Cx-Query/Cx-Select-Pull information flow to the HSS (Public User Identity, Private User Identity, P-CSCF network identifier). The HSS shall check whether or not the user is registered already. The HSS shall indicate whether or not the user is allowed to register in that P-CSCF network (identified by the P-CSCF network identifier) according to the User subscription and operator limitations/restrictions.

In the step S804, Cx-Query Resp/Cx-Select-Pull Resp is sent from the HSS to the I-CSCF. It shall contain the S-CSCF name, if it is known by the HSS, or the S-CSCF capabilities, if it is necessary to select a new S-CSCF. When capabilities are returned, the I-CSCF shall construct a name from the capabilities returned. If the checking in HSS was not successful, the Cx-Query Resp shall reject the registration attempt.

In the step S805, the I-CSCF, using the name of the S-CSCF, shall determine the address of the S-CSCF through a name-address resolution mechanism. The name-address resolution mechanism is allowed to take the load information of the S-CSCFs (e.g. obtained using network management procedures) into consideration when deciding the address of the S-CSCF. The I-CSCF also determines the name of a suitable home network contact point, possibly based on information received from the HSS. I-CSCF shall then send the register information flow (P-CSCF address/name, Public User Identity, Private User Identity, P-CSCF network identifier, UE IP address) to the selected S-CSCF. The home network contact point will be used by the P-CSCF to forward session initiation signaling to the home network.

The S-CSCF shall reject the registration if the number of registered contact addresses for a Public User Identity from the same UE exceeds the limit of simultaneous registrations configured at the S-CSCF. The S-CSCF shall also reject the registration from separate UEs if the allowed number of simultaneous registrations according to the S-CSCF configuration or per subscribed value for a Public User Identity received from the HSS exceeds the limit of simultaneous registrations. The S-CSCF shall store the P-CSCF address/name, as supplied by the visited network. This represents the address/name that the home network forwards the subsequent terminating session signaling to the UE. The S-CSCF shall store the P-CSCF Network ID information.

In the step S806, the S-CSCF shall send Cx-Put/Cx-Pull (Public User Identity, Private User Identity, S-CSCF name) to the HSS.

In the step S807, the HSS shall store the S-CSCF name for that user and return the information flow Cx-Put Resp/Cx-Pull Resp (user information) to the S-CSCF. The user information passed from the HSS to the S-CSCF shall include one or more names/addresses information which can be used to access the platform(s) used for service control while the user is registered at this S-CSCF. The S-CSCF shall store the information for the indicated user. In addition to the names/addresses information, security information may also be sent for use within the S-CSCF.

In the step S808, based on the filter criteria, the S-CSCF shall send register information to the service control platform and perform whatever service control procedures are appropriate.

In the step S809, the S-CSCF shall return the response message (200 OK) information flow (home network contact information, a GRUU set) to the I-CSCF.

In the step S810, the I-CSCF shall send information flow 200 OK (home network contact information, a GRUU set) to the P-CSCF. The I-CSCF shall release all registration information after sending the information flow (200 OK).

In the step S811, the P-CSCF shall store the home network contact information, and shall send information flow 200 OK (a GRUU set) to the UE. The P-CSCF may subscribe at the PCRF to notifications of the status of the IMS Signaling connectivity (refer to 3GPP TS 23.203). If the S-CSCF receives the priority information of the MPS subscribed-UE as a part of user profile from the HSS, the S-CSCF provides the priority information to the P-CSCF and the P-CSCF stores this information for the MPS-subscribed UE.

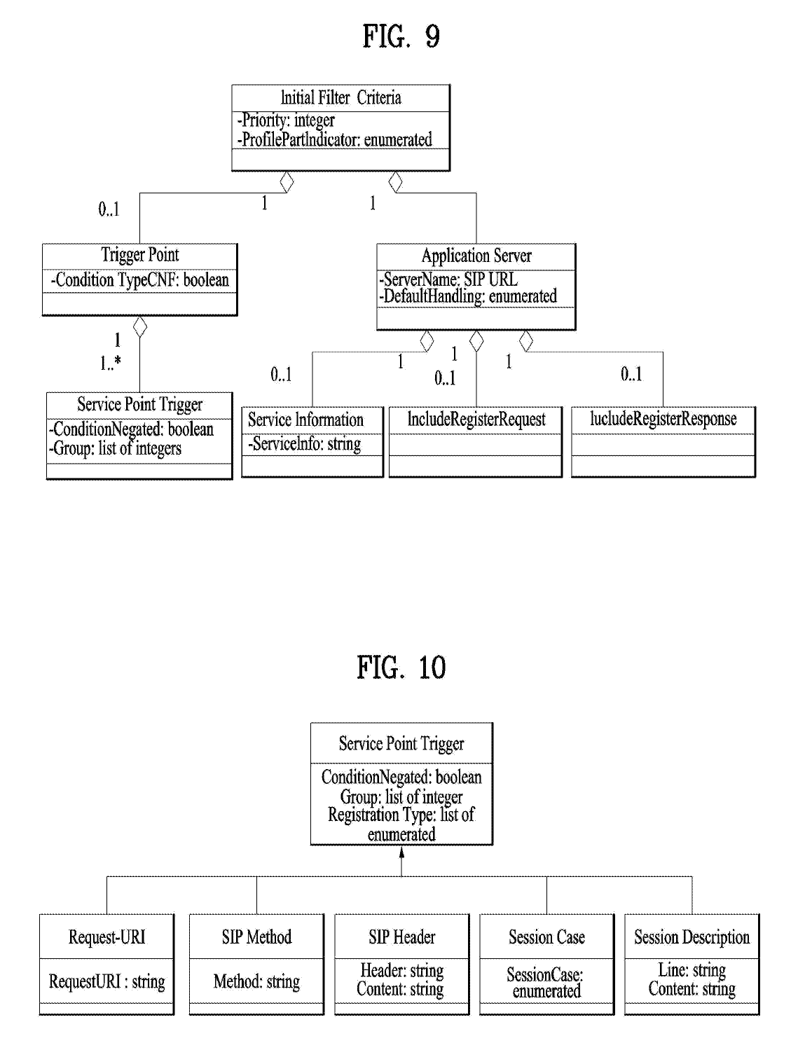

FIG. 9 is a diagram for explaining initial filter criteria (IFC).

Each instance of the Initial Filter Criteria class is composed of zero or one instance of a Trigger Point class and one instance of an Application Server class. Priority indicates the priority of the Filter Criteria. The higher the Priority Number the lower the priority of the Filter Criteria. In particular, a Filter Criteria with a higher value of Priority Number shall be assessed after the Filter Criteria with a smaller Priority Number have been assessed. The same priority shall not be assigned to more than one initial Filter Criterion.

ProfilePartlndicator attribute is an enumerated type, with possible values “REGISTERED and UNREGISTERED, indicating if the IFC is a part of the registered or unregistered user profile. If ProfilePartlndicator is missing from the IFC, the IFC is considered to be relevant to both the registered and unregistered parts of the user profile, i.e. belongs to the common part of the user profile. Trigger Point class describes the trigger points that should be checked in order to find out if the indicated Application Server should be contacted or not. Each TriggerPoint is a Boolean expression in Conjunctive or Disjunctive Normal form (CNF of DNF). The absence of Trigger Point instance will indicate an unconditional triggering to Application Server.

The attribute ConditionTypeCNF attribute defines how the set of SPTs are expressed, i.e. either an Ored set of ANDed sets of SPT statements or an ANDed set of Ored sets of statements. Individual SPT statements can also be negated. These combinations are termed, respectively, Disjunctive Normal Form (DNF) and Conjunctive Normal Form (CNF) for the SPT. Both DNF and CNF forms can be used. ConditionTypeCNF is a Boolean that is TRUE when the Trigger Point associated with the FilterCriteria is a Boolean expression in Conjunctive Normal Form (CNF) and FALSE if the Trigger Point is expressed in Disjunctive Normal Form (DNF).

Each Trigger Point is composed by 1 to n instances of the class Service Point Trigger. Application Server class defines the application server, which is contacted, if the trigger points are met. Server Name is the SIP URL of the application server to contact. Default Handling determines whether the dialog should be released if the Application Server could not be reached or not; it is of type enumerated and can take the values: SESSION_CONTINUED or SESSION_TERMINATED.

The Application Server class contains zero or one instance of the Service Information class, zero or one instance of the Include Register Request class and zero or one instance of the Include Register Response class. The Service Information class allows to download to S-CSCF information that is to be transferred transparently to an Application Server when the trigger points of a filter criterion are satisfied. ServiceInformation is a string conveying that information. For a description of the use of this information element, it may refer to 3GPP TS 23.218. The Include Register Request class indicates to the S-CSCF that the incoming SIP REGISTER request is to be transferred to an Application Server when the trigger points of a filter criterion are satisfied. For a description of the use of this information element, it may refer to 3GPP TS 23.218 . The Include Register Response class indicates to the S-CSCF that the final SIP response to the incoming SIP REGISTER request is to be transferred to an Application Server when the trigger points of a filter criterion are satisfied. For a description of the use of this information element, it may refer to 3GPP TS 23.218.

FIG. 10 is a diagram for explaining a service point trigger.

Referring to FIG. 10, the attribute Group of the class Service Point Trigger allows the grouping of SPTs that will configure the sub-expressions inside a CNF or DNF expression. For instance, in the following CNF expression (A+B·(C+D), A+B and C+D may correspond to different groups. In CNF, the attribute Group identifies the ORed sets of SPT instances. If the SPT belongs to different ORed sets, SPT can have more than one Group values assigned. At least one Group must be assigned for each SPT. In DNF, the attribute Group identifies the ANDed sets of SPT instances. If the SPT belongs to different ANDed sets, SPT can have more than one Group values assigned. At least one Group must be assigned for each SPI. The attribute ConditionNegated of the class Service Point Trigger defines whether or not the individual SPT instance is negated (i.e. NOT logical expression). (Note: The operator should be aware that a negated Session Case implies that all other available session cases are set. The list of session cases depends on the release and can even be increased in the future, then a negated Session Case may end up triggering ASs unexpectedly (e.g. NOT ORIGINATED_REGISTERED may trigger only TERMINATING_UNREGISTERED and TERMINATING_REGISTERED, or as well ORIGINATING_UNREGISTERED and ORIGINATING_CDIV).

The attribute RegistrationType of the class Service Point Trigger is relevant only to the SIP Method SPT with a value of “REGISTER” and its' support is optional in the HSS and in the S-CSCF. The RegistrationType may contain a list of values that define whether the SPT matches to REGISTER messages that are related to initial registrations, re-registrations, and/or de-registrations. If RegistrationTypes are given, the SIP Method SPT with a value of “REGISTER” shall match if any of the RegistrationTypes match and the S-CSCF supports the RegistrationType attribute. If the SIP Method SPT contains value “REGISTER”, and no RegistrationType is given, or if the S-CSCF does not support the RegistrationType attribute, the SIP Method SPT matches to all REGISTER messages. The attribute RegistrationType may be discarded if it is present in an SPT other than SIP Method with value “REGISTER”.

Request-URI class defines SPT for the Request-URI. Request-URI contains attribute RequestURl. SIP Method class defines SPT for the SIP method. SIP Method contains attribute Method which holds the name of any SIP method. SIP Header class defines SPT for the presence or absence of any SIP header or for the content of any SIP header. SIP Header contains attribute Header which identifies the SIP Header, which is the SPT, and the Content attribute defines the value of the SIP Header if required. The absence of the Content attribute and ConditionNegated=TRUE indicates that the SPT is the absence of a determined SIP header.

Session Case class represents an enumerated type, with possible values “Originating”, “Terminating_Registered”, “Terminating_Unregistered”, “Originating_Unregistered”, “Originating_CDIV” indicating whether the filter should be used by the S-CSCF handling the Originating, Terminating for a registered end user, Terminating for an unregistered end user, Originating for an unregistered end user, or Originating after Call Diversion services. Session Description Information class defines SPT for the content of any SDP field within the body of a SIP Method. The Line attribute identifies the line inside the session description. Content is a string defining the content of the line identified by Line.

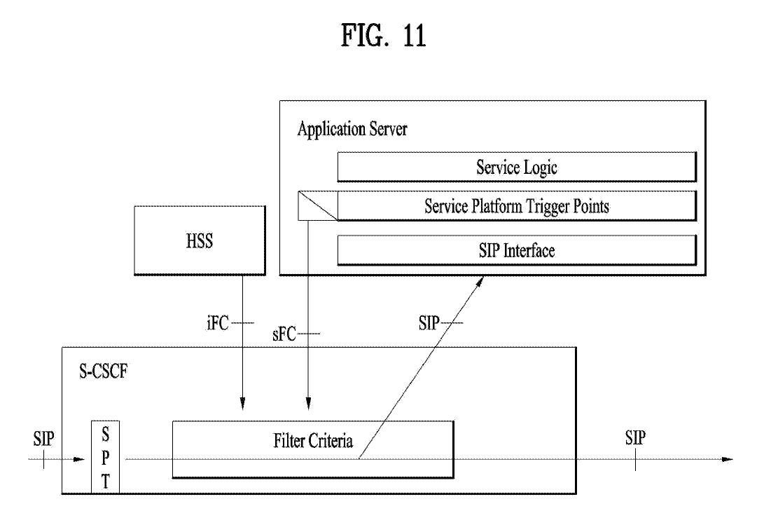

In the following, S-CSCF Filter Criteria is explained with reference to FIG. 11 illustrating an application triggering structure.

The S-CSCF shall request from the HSS the relevant set of IFCs that applies to the served user (i.e., registered, unregistered, or both). If the S-CSCF has a set of IFCs that is deemed valid (e.g., from a previous request), the S-CSCF need not request a new set. In the case that multiple Filter Criteria are sent from the HSS to the S-CSCF, the S-CSCF shall check the filter criteria one by one according to their indicated priority when the S-CSCF receives a message via the Mw interface. On reception of a REGISTER request, the S-CSCF shall send a third-party REGISTER request to each Application Server that matches the Filter Criteria sent from the HSS for the REGISTER request. The S-CSCF shall include in the third-party REGISTER request the incoming REGISTER request if indicated by the Filter Criteria. The S-CSCF shall include in the third-party REGISTER request the final response to the incoming REGISTER request if indicated by the Filter Criteria.

On an event that causes network-initiated deregistration, the S-CSCF shall send a third-party REGISTER request to each Application Server that matches the Filter Criteria sent from the HSS as if an equivalent REGISTER request had been received from the user deregistering that public user identity, or combination of public user identities.

On reception of any other request the S-CSCF shall perform the following.

1. Set up the list of filter criteria for that request according to their priority—the sequence of the filter criteria shall not be changed until the request finally leaves the S-CSCF via the Mw interface again.

2. Parse the received request in order to find out the Service Point Triggers (SPTs) that are included in it.

3. Check whether the trigger points of the filter criteria with the next highest priority are matched by the SPTs of the request.

a) If it does not match, the S-CSCF shall immediately proceed with step 4.

b) If it matches, the S-CSCF shall:

i) add an Original Dialog Identifier (ODI) to the request which will allow the S-CSCF to identify the message on the incoming side, even if its dialog identification has been changed e.g. due to the Application Server performing third party call control;

ii) forward the request via the ISC interface to the Application Server indicated in the current filter criteria. The Application Server then performs the service logic, may modify the request and may send the request back to the S-CSCF via the ISC interface;

iii) proceed with step 4 if a request with the same ODI is received from the Application Server via the ISC interface.

4. Repeat the above steps 2 and 3 for every filter criteria which was initially set up (in step 1) until the last filter criteria has been checked.

5. Route the request based on normal SIP routing behaviour.

If an Application Server decides to locally terminate a request and sends back a final response for that request via the ISC interface to the S-CSCF, the S-CSCF shall abandon verification of the matching of the triggers of lower priority in the list. (If AS has service logic whereby it wishes to send a request to the S-CSCF to continue with filter criteria evaluation from where it left off with the final response to the previous request, then a new request must be sent with data that can be used by the S-CSCF to determine where it left off with filter criteria evaluation. For example, a parameter can be included in the request that is also defined in a service point trigger.)

Each invoked Application Server/service logic may decide not to be engaged with the invoked session by indicating that during the very first SIP transaction when the Record-Route/Route is generated for subsequent SIP requests. The denial shall mean that subsequent requests shall not be routed to such Application Servers/service logic any more during the lifetime of that session. Any Application Server, which has determined that it will not receive subsequent requests for a session cannot revoke this determination by means of Initial Filter Criteria (IFC).

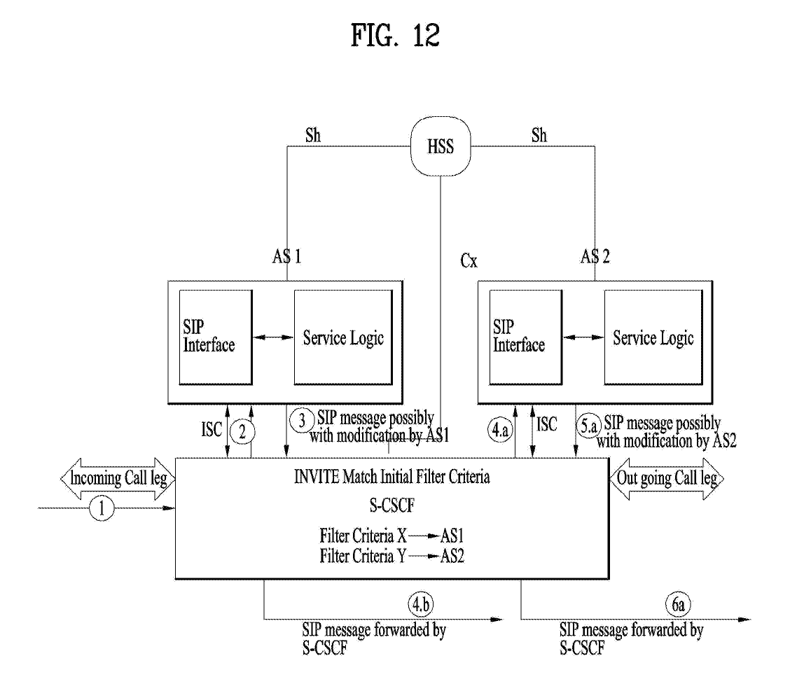

FIG. 12 is a diagram illustrating an example of IFC triggering.

In FIG. 12, two application servers are assigned to provide additional services to a subscriber and they are showed as AS1 and AS2 in this example.

1. User initiates a SIP session by sending a SIP initial request to its S-CSCF.

2. On receiving this request, the S-CSCF evaluates the SPTs and checks if they match the initial filter criteria X for AS1. If they match, the S-CSCF forwards this request to AS1.

3. The AS1 performs any needed service logic based on the Service Key and sends the SIP request possibly with service related modification back to the S-CSCF.

4a. On receiving the request from the AS, the S-CSCF evaluates the SPTs and checks if they match the initial filter criteria Y for AS2. If they match the S-CSCF forwards the request to the associated Application Server AS2.

4b. If the request doesn't match any further filter criteria, the S-CSCF forwards this request to the next hop based on the route decision.

5a. The AS2 performs any needed service logic based on the Service Key and sends the SIP request possibly with service related modification back to the S-CSCF.

6a. The S-CSCF checks the request sent by AS2 and finds that no initial criteria is matched, then the S-CSCF forwards this request to next hop based on the route decision.

Traditionally, voice call is one of the most important functions provided by a terminal device. In a cellular network, in order to efficiently provide the voice call, a scheme of consistently allocating a stationary wired/wireless resource during the voice call based on a pattern optimized to voice has been used. In particular, when a user is doing voice call, although the user fails to receive voice information during a short time period, the user is able to understand most of contents. However, if voice information is forwarded later than expected, the user may have dissatisfaction against service quality. Hence, the scheme makes the voice information of the user to be immediately transmitted by consistently allocating a resource during the voice call in consideration of the abovementioned property. The scheme is referred to as a circuit-switch scheme and is used in a traditional wire calling system and a cellular network.

While voice call is performed, a caller does not consistently speak. The caller listens to what a counterpart says when the counterpart says. In this case, if a radio resource is consistently allocated to the caller, it leads to the waste of the radio resource and call volume capable of being supported by a system at the same time can be restricted. In order to solve the problem, a packet-switch scheme is proposed. All of Internet data are forwarded through the packet-switch scheme. In accordance with the explosive increase and dissemination of the Internet, voice call is also provided via a network using the packet-switch scheme. One example of the voice call is VoLTE (or IMS voice). Recently, a service provider providing a voice call service using the packet-switch scheme, i.e., VoLTE, has appeared. Hence, it is anticipated that a terminal device supporting the packet-switch scheme only will appear in near future.

Currently, a terminal device provides such a switch as “mobile data”. Mostly, the switch is software configured and is provided by UI (user interface) related to a configuration of the terminal device. The “mobile data” switch makes a user of the terminal device determine whether to block an internet connection function. In particular, since there is a restriction on monthly usable data amount depending on calling plan of users, each of the users uses the internet connection function through the switch only when the function is needed to handle internet traffic not to exceed the data amount usable by the user.

If a user blocks the internet connection function by turning the mobile data switch off, voice call provided via the internet connection function is not provided as well. In case of a network providing the packet-switch (hereinafter, PS) only or in case of a UE providing the PS only, since the user is unable to use a voice call service via a circuit switch (hereinafter, CS) network, the user is able to use no voice call at the moment that the user turns the mobile switch off. Since it is necessary for a terminal device to provide voice call at least, if the mobile data switch blocks all internet traffic, it becomes a problem.

Hence, although the mobile data switch is turned off, it is necessary to transmit a minimum internet data service or an internet packet for a specific data service to a UE.

And, if the mobile data switch is turned off, it is necessary for a network to efficiently block data transmitted to the terminal device in downlink direction. In particular, it is necessary to have a device capable of passing a data related to a minimum service and blocking data related other services.

Prior to the explanation of the present invention, terminologies are defined as follows.
DataOff function: When a user activates a DataOff function, packets related to DataOff Exempt Services services are transmitted and packets related to other services are blocked. If the DataOff function is deactivated, all packets are transmitted. The DataOff function is also referred to as a PS DataOff function, a 3GPP DataOff function, or a 3GPP PS DataOff function.
DataOff Exempt Services: A service which is provided/permitted even when the DataOff function is activated. For example, the service may include following services.
Supplementary Service settings management via the Ut interface using XCAP (XML Configuration Access Protocol);
voice calls over IMS;
SMS over IMS;
Device Management over PS;
USSD (Unstructured Supplementary Service Data) over IMS (USSI);
services that are part of the Rich Communication Suite (RCS) as defined in GSMA PRD RCC.61

The present invention relates to a communication system capable of providing a minimum service to a user and blocking unnecessarily generated data call by permitting a data flow for a service mandatorily supported to a UE and selectively blocking other data flow when the user configures a mobile data use to be turned off in the UE of the user and a method of controlling therefor. In the following, a system for supporting DataOff function and methods therefor are explained according to the present invention.

According to the present invention, a UE can inform a network of whether or not the UE supports a DataOff function. By doing so, the network providing the DataOff function can distinguish a UE supporting the DataOff function from a UE not supporting the DataOff function. For example, the network transmits information on the ExemtService to the UE supporting the DataOff function and does not transmit the information on the ExemtService to the UE not supporting the DataOff function. In particular, although a user of the UE supporting the DataOff function turns the DataOff function on, the UE can determine a data for a certain service to be transmitted and a data for a certain service to be deleted. Preferably, in the abovementioned procedure, information on whether or not the DataOff function is supported can be included in a message such as ATTACH REQUEST message, Tracking Area Update message, a message having the equivalent purpose, e.g., a message for forwarding capability information of a UE, or a message including an information element. Preferably, in the abovementioned procedure, a network includes nodes including MME, eNB, S-GW, P-GW, PCRF, P-CSCF, and the like in E-UTRAN and nodes in EPC and can forward the capability information of the UE between the nodes.

According to the present invention, if a user of the UE activates or deactivates the DataOff function, the UE can transmit information on the activation/deactivation of the DataOff function to a network. If the network does not have the information, the network is unable to determine whether to transmit data to the UE in a certain situation. The network is able to know whether the DataOff function is activated or deactivated in a certain UE via the information and can properly operate in accordance with the state of the UE. For example, when the DataOff function of a UE is deactivated, if a P-GW or an S-GW has data to be transmitted to the UE in DL, the P-GW or the S-GW forwards the data to the UE irrespective of a type and content of the data. For example, when the DataOff function of a UE is activated, if a P-GW or an S-GW has data to be transmitted to the UE in DL and the data corresponds to ExemptService, the P-GW or the S-GW forwards the data to the UE. Otherwise, in particular, if the data does not correspond to ExemptService, the P-GW or the S-GW deletes the data or does not forward the data to the UE.

According to the present invention, the network forwards information on whether or not the network supports the DataOff function or information on whether or not the DataOff function is activated to the UE. For example, assume a case that a user travels abroad. And, assume that a communication network to which the user originally subscribes in a home country of the user supports a DataOff function. When a communication network of a location at which the user is located does not support the DataOff function, if the user activates the DataOff function, since the current communication network does not understand the DataOff function, the communication network transmits internet traffic for all services to the user. As a result, the user pays expensive roaming charge. Hence, according to the present invention, it is necessary for a network to inform a UE of whether or not the network supports the DataOff function. The UE determines whether to activate the DataOff function according to the functionality of the network and operates by determining whether the function is blocked or permitted. To this end, it may consider additional methods described in the following. Contents described in the following alternatives can be used in a manner of being mixed.

Alt. 1: A communication network to which a user and a UE are subscribing provides the UE with information on a communication network capable of using the DataOff function or a communication network incapable of using the DataOff function. For example, if a communication network A informs a UE subscribing to the communication network A that the DataOff function is available in a communication network B, the UE uses the DataOff function in the communication network B and does not use the DataOff function in a communication network C.

A communication network to which a user belongs thereto informs the user of information on the communication network via OMA (Open Mobile Alliance) DM (Device Management) to indicate whether or not the communication network is able to use the DataOff function.

Such a network node of EPC as MME informs the UE of the information on the communication network capable/incapable of using the DataOff function.

The information on the communication network can include PLMN ID and the like.

It may be able to additionally include information on a specific region as well as the information on the communication network. In particular, a network informs a UE of information on whether or not the network is able to use the DataOff function in the region based on the information on the region and the UE operates according to the information.

Alt. 2: Each eNB informs a UE of information on whether or not the DataOff function is supported according to a communication network. When the UE attempts to access a communication network, the UE is able to know whether or not the communication network supports the DataOff function based on the information. For example, if a UE supporting the DataOff function searches for cells in a certain region and receives SIB from the cells, the UE is able to know whether or not the cells or PLMN to which the cells belong thereto support the DataOff function.

The UE supporting the DataOff function attempts to access, register, or connect to a communication network, a cell, or a PLMN supporting the DataOff function.

The UE supporting the DataOff function selects a cell to be accessed by the UE from among cells searched by the UE according to a criterion such as radio quality or the like. If the cell supports the DataOff function, the UE may attempt to connect/access/register at the cell.

The UE supporting the DataOff function selects a cell to be accessed by the UE from among cells searched by the UE according to a criterion such as radio quality or the like. If the cell does not support the DataOff function, the UE may not attempt to connect/access/register at the cell.

Alt. 3: When a UE transmits such a NAS message as Service Request, Tracking update, Attach request or an RRC connection request to a network to attempt to connect/access/register at the network, if the network supports the DataOff function, the network transmits a response message to the UE in a manner of including information indicating that the DataOff function is supported in such a message as Service Accept, Tracking update accept, Attach accept. If the network does not support the DataOff function, the network transmits a response message to the UE in a manner of including information indicating that the DataOff function is not supported in such a message as Service Accept, Tracking update accept, Attach accept. If the information indicating that the DataOff function is supported is not included in such a message as Service Accept, Tracking update accept, Attach accept, the UE determines that the network does not support the DataOff function.

If the network informs the UE that the network does not support the DataOff function, the UE may immediately disconnect an access to the network. In particular, the UE can perform a detach procedure.

Alt 4: If the network informs the UE that the network does not support the DataOff function or does not inform the UE of relevant information, the UE informs a user that the currently accessed network does not support the DataOff function. Subsequently, the UE may operate like the UE does not support the DataOff function.

If the UE operates like the UE does not support the DataOff function or does not support the DataOff function in a network at which the UE is staying, the UE may not display a DataOff button on a user interface.

When the UE operates like the UE does not support the DataOff function or does not support the DataOff function in a network at which the UE is staying, if a user activates the DataOff function, the UE may cancel the registration with the network. For example, when the UE operates like the UE does not support the DataOff function or does not support the DataOff function in a network at which the UE is staying, if a user activates the DataOff function, the UE may perform a detach procedure or may not access/connect/register at the network. When the UE operates like the UE does not support the DataOff function or does not support the DataOff function in a network at which the UE is staying, if a user deactivates the DataOff function, the UE may maintain the registration with the network.

If the UE operates like the UE does not support the DataOff function or a network at which the UE is staying informs the UE that the network does not support the DataOff function, the UE may immediately cancel the registration with the network. For example, if the UE operates like the UE does not support the DataOff function or a network at which the UE is staying informs the UE that the network does not support the DataOff function, the UE may perform a detach procedure or may not access/connect/register at the network. Or, the UE may operate like the UE has received ATTCH Reject or Tracking Area update Reject.

Meanwhile, when the UE informs the network that a user of the UE has activated the DataOff function, if the DataOff function of the network is activated as well, the network can inform the UE that the DataOff function of the network is activated. If the user activates the DataOff function, the UE informs the network that the DataOff function is activated. If the network activates the DataOff function for the UE, the network informs the UE that the DataOff function is activated. The network may include MME, S-GW, P-GW, and the like. When the UE informs the network that the DataOff function is activated, if the UE fails to receive information indicating that the DataOff function is activated in the network or activation of the DataOff function has failed in the network from the network, the UE may consider that the DataOff function is not activated in the network. The UE may use such a message as TAU request, Attach request, Service request to transmit the information indicating that the user of the UE has activated the DataOff function. Having received the information, the network may use such a message as TAU accept, TAU reject, ATTACH accept, ATTACH reject, Service request accept, or Service request reject to transmit information indicating whether the DataOff function is successful or failed in the network. If the UE determines that the DataOff function is not activated in the network or receives information indicating that the DataOff function is not activated from the network, the UE may not use the DataOff function. In addition, operations described in the following can be selectively performed.
The UE does not display a DataOff button on a user interface.
If a user activates the DataOff function, the UE cancels the registration with the network. Preferably, the UE performs a detach procedure or may not access/connect/register at the network.
If a user deactivates the DataOff function, the UE maintains the registration with the network.
The UE immediately cancels the registration with the network. Preferably, the UE performs a detach procedure or may not access/connect/register at the network. Or, the UE operates like the UE has received ATTACH Reject or Tracking Area update Reject.

Meanwhile, if DataOff function is activated in a UE, the present invention proposes a method for a network to efficiently block the delivery of data of a service rather than ExemptService to the UE to prevent a user of the UE or a subscriber from being unnecessarily charged.

To this end, if the UE informs an MME that the DataOff function is activated, the MME informs an S-GW that the DataOff function is activated in the UE. The S-GW additionally forwards the same information to a P-GW, the P-GW additionally forwards the same information to a PCRF, and the PCRF additionally forwards the same information to a P-CSCF. In particular, the MME receives information on the activation of the DataOff function from the UE and the information is disseminated into network nodes. Yet, the UE may directly forward the information to the P-CSCF. In particular, since the UE receives address information of the P-CSCF from the network via such a procedure as ATTACH, or the like, the UE can directly inform the P-CSCF that the DataOff function of the UE is activated.

When a P-CSCF receives information indicating that a DataOff function of a UE is activated, if the P-CSCF receives messages (e.g., SIP (session initiation protocol) message) corresponding to the UE, the P-CSCF analyses the SIP message and examines whether or not a service corresponding to the SIP message is included in ExemptService. If the service corresponding to the SIP message is not included in the ExemptService, the P-CSCF performs marking on a header of an IP packet including the SIP message and forwards the IP packet to a P-GW.

If the P-GW receives an IP packet corresponding to a certain UE, the P-GW analyses a header of the IP packet. If a special mark is on the header of the IP packet, the P-GW deletes the IP packet. If a special mark does not exist on a header of a received IP packet, the P-GW forwards the IP packet to an S-GW. The abovementioned operation may occur not only in the P-GW but also in the S-GW. In particular, the P-GW simply forwards the IP packet to the S-GW without checking the header of the IP packet. The S-GW checks the header of the IP packet and may delete the IP packet if necessary. In this case, when special marking is performed on an IP header, it means that a value of a specific field of the IP header is replaced with a predetermined value.

As a different implementation method of the present invention, if a UE activates a DataOff function, an MME forwards information on ExemptService of the UE or information on a service rather than the ExemptService to a P-GW/S-GW. Subsequently, the P-GW or the S-GW generates a filter for the ExemptService or a filter for the service rather than the ExemptService. If an IP packet corresponding to the UE arrives, the P-GW or the S-GW compares the IP packet with the filter and determines whether to delete data or whether to forward the IP packet to the UE. The filter corresponds to information capable of identifying a specific service and can be configured by a combination of an IP address of a receiver, an IP address of a transmitter, a specific port number, and the like. In addition, the filter includes information indicating whether the identified IP packet is forwarded or deleted, information on a bearer to be used for forwarding the IP packet, and the like. An example of the filter includes TFT (Traffic Flow Template), and the like.

If the same ExemptService is set to all UEs of a certain communication company, the MME may inform the P-GW or the S-GW of information on whether or not the DataOff function is activated only. The P-GW or the S-GW performs examination on an IP packet to be transmitted to the UE using a filter for predetermined ExemptService or a filter for a service rather than the ExemptService and determines whether the IP packet is deleted or forwarded. In particular, the P-GW or the S-GW can perform packet filtering. Since the P-GW corresponds to a first GW where a packet is received from an external network, if the P-GW performs filtering, operations after the P-GW can be omitted together.

A network manager provides a policy of the network manager to all P-GWs of the network manager via a PCRF. Hence, a P-GW can receive configuration information related to the DataOff from the PCRF or the like. For example, in order to obtain filter information to be applied to a UE of which the DataOff is activated, if the DataOff is activated in a certain UE, the P-GW informs the PCRF of the activation of the DataOff of the UE. The PCRF generates a new filter to be applied to the UE and informs the P-GE of the newly generated filter. Subsequently, if the P-GW receives an IP packet heading towards the UE using the filter information, the P-GE compares the IP packet with the filter and may delete the IP packet if necessary.

A user may activate the DataOff function in the middle of performing a phone call or a session. In this case, the phone call or the session may not correspond to ExemptService. In this case, it is preferable to immediately block the phone call or the session. To this end, if the DataOff function is activated, the P-GW, the PCRF, or the MME/UE informs a P-CSCF that the DataOff function is activated in a specific UE. In this case, the P-GW or the PCRF forwards information on ExemptService to the P-CSCF. The P-CSCF inquiries into the phone call or the session currently performed in the UE and checks whether or not there is a service rather than the ExemptService. If there is a service rather than the ExemptService in the currently performed phone call or the session, the P-CSCF informs the P-GW of information on the currently performed phone call or the session via the PCRF. The information on the currently performed phone call or the session can be configured in a manner of being similar to the aforementioned filter. In particular, the information can include information necessary for the P-GW to identify the currently performed phone call or the session (e.g., an IP address of a transmitter or a receiver, a port number, a different header included in an IP packet, information on a header of a higher layer packet included in an IP packet, and the like). Or, the P-CSCF may inform other CSCF nodes of the information to make the CSCF perform an operation of cancelling the call. Or, in case of incoming call or originating call for the UE, if the call does not correspond to ExempService, the CSCF may block the call.

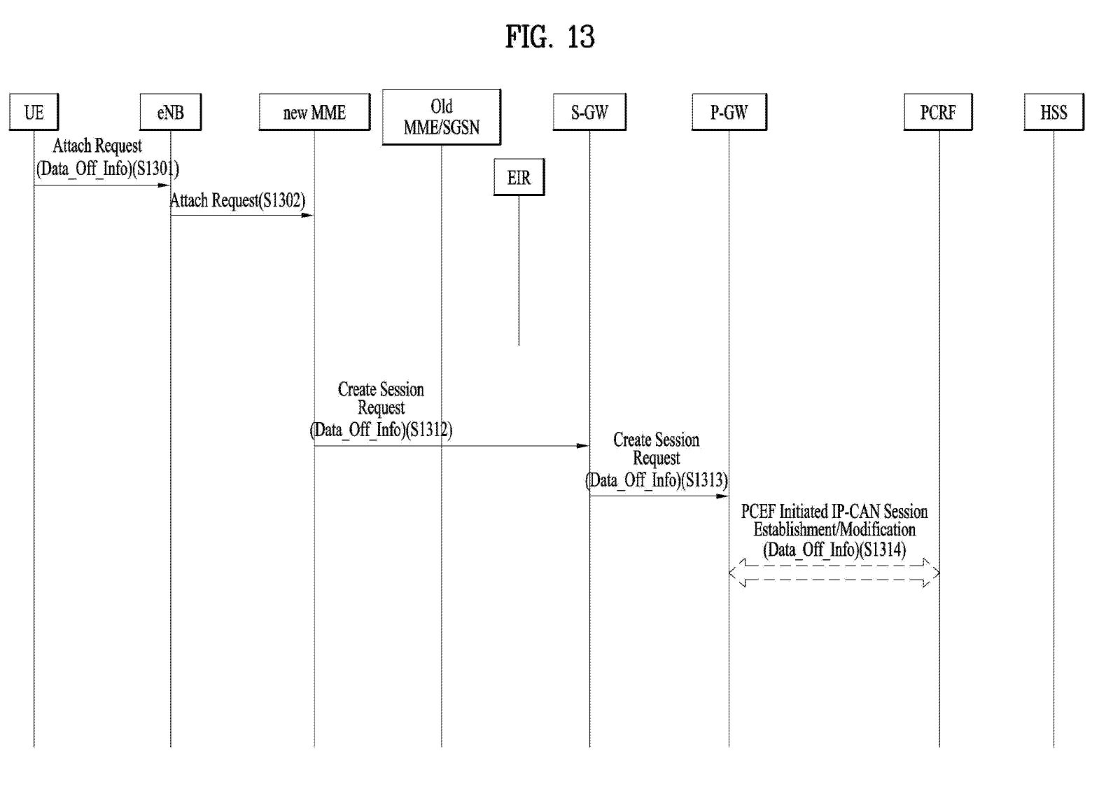

FIG. 13 is a flowchart illustrating a data-off function according to the present invention with reference to an attach procedure. FIG. 13 simply illustrates a part of the attach procedure mentioned earlier in FIG. 5. An example for a method of supporting DataOff function according to the present invention is described in the following with reference to FIG. 13.

S1301/S1302. An attach request message transmitted by a UE is forwarded to an MME. The attach request message transmitted by the UE includes information on whether or not the UE supports the DataOff function and/or information (Data_Off_Info) on whether or not the DataOff function is activated in the UE.

S1303 to S1311. Operations performed in a network. Refer to the steps S503 to S511 mentioned earlier in FIG. 5.

S1312, S1313. The MME forwards the information on the DataOff of the UE to an S-GW and additionally forwards the information to a P-GW. The P-GW becomes aware of a DataOff state of the UE via the information on the DataOff.

S1314. The P-GW receives policy information according to the DataOff via a PCRF. For example, if the UE activates the DataOff function, the PCRF forwards filter information on a service to be blocked and filter information on a service not to be blocked to the P-GW. Since the P-GW receives the filter information from the PCRF, the P-GW deletes a packet matched with the service to be blocked or a packet matched with a filter for the service to be blocked and forwards the remaining data to an eNB.

Meanwhile, as a further different implementation method of the present invention, when a user activates the DataOff function, if a phone call request or a session request is transmitted to the user, a network can transmit a response in response to the request on behalf of the user. In particular, assume a case that a user B makes a call to a user A of which DataOff function is activated. In this case, an invite message is generated in a UE of the user B and the invite message is going to be forwarded to an IMS network to which a UE of the user A is connected. The invite message is forwarded to a P-CSCF, an I-CSCF, and an S-CSCF in charge of the UE of the user A. In this case, if the user A activates the DataOff function before a phone call is made to the user A, the UE of the user A informs a network that the DataOff function is activated. In particular, as mentioned earlier in a different part of the present invention, this information on the activation of the DataOff function is forwarded to the P-CSCF or other CSCF. For example, the UE forwards information on whether the DataOff function is activated or deactivated and information on a service belonging to ExemptService and a service not belonging to the ExemptService to many CSCFs including the P-CSCF. The P-CSCF additionally forwards the information to the S-CSCF or the I-CSCF. As a different method, if an MME receives information indicating that DataOff function is activated and information on ExemptService from the UE of the user A, the MME can store the information in an HSS. When the invite message is received from the UE of the user B, the I-CSCF or the S-CSCF brings information on the UE of the user A from the HSS. In this case, the S-CSCF or the I-CSCF is able to know whether or not the DataOff function is activated in the UE of the user A.

In particular, if the S-CSCF, the I-CSCF, or the P-CSCF receives an invite message (i.e., a terminating call request) for a UE, the S-CSCF, the I-CSCF, or the P-CSCF checks whether or not the DataOff function is activated in the UE and additionally examines whether or not a service requested by the invite message corresponds to ExemptService. As a result, if the DataOff function is deactivated or a service requested by the invite message corresponds to the ExemptService, the S-CSCF, the I-CSCF, or the P-CSCF forwards the invite message to the UE. If the DataOff function is activated and the service requested by the invite message does not correspond to the ExemptService, the S-CSCF, the I-CSCF, or the P-CSCF deletes the invite message. Or, if the DataOff function is activated and the service requested by the invite message does not correspond to the ExemptService, the S-CSCF, the I-CSCF, or the P-CSCF generates a reject message in response to the invite message and transmits the reject message to a network or a UE, which has transmitted the invite message. The reject message may use 4XX type message of SIP signaling. In addition, when the reject message is transmitted in response to the invite message, the S-CSCF, the I-CSCF, or the P-CSCF may additionally include information on a cause for transmitting the reject message in the reject message. For example, such a cause as a target of receiving the phone call activates the DataOff function, Internet connection is disconnected, or a service set to the user is not the ExemptService can be included in the reject message. By doing so, the user B, who has originally made a phone call, is able to know that the user A turns a telephone off or the DataOff function is activated. Hence, it may be able to make the user B not to attempt to make an additional call.

And, the object of the present invention can be achieved through nodes of IMS network for the currently performed phone call. In particular, when a UE makes a phone call, if information indicating that the DataOff function of the UE is activated is forwarded to the S-CSCF, the I-CSCF, or the P-CSCF using the abovementioned method, the S-CSCF, the I-CSCF, or the P-CSCF checks whether or not there is a currently performed phone call or a session in the UE. If there is a currently performed phone call or a session in the UE, the S-CSCF, the I-CSCF, or the P-CSCF examines whether or not the phone call or the session is included in the ExemptService. If the phone call or the session is not included in the ExemptService, the S-CSCF, the I-CSCF, or the P-CSCF performs an operation for terminating the phone call or the session. For example, the S-CSCF, the I-CSCF, or the P-CSCF generates a bye message and forwards the bye message to each of UEs or nodes of IMS network in charge of each of the UEs to terminate the phone call or the session. In this case, information on a cause for terminating a phone call can be included in the bye message.

A service included in the ExemptService may vary depending on a communication company. Hence, it is necessary for a network to inform a UE of information on a service included in the ExemptService. To this end, the network forwards information on the ExemptService to each UE. Having received the information, a UE is able to know a service to be blocked and a service to be permitted when a user activates the DataOff function. The information on the ExemptService may include the following.
Information on applications which are permitted even when the DataOff function is activated: For example, a name of an application or an ID. When the DataOff function is activated, if a new data is generated, a UE compares information on an application, which has generated the data, with application information of the ExemptService. If the application corresponds to the ExemptService, the UE performs an operation for transmitting the data to a network. Otherwise, the UE deletes the data.
Filter information related to ExemptService: For example, IP packet header information, etc. When the DataOff function is activated, if a new data is generated, a UE compares information on an IP packet header of the data with filter information designated by the ExemptService. If the data corresponds to the ExemptService, the UE performs an operation for transmitting the data to a network. Otherwise, the UE deletes the data.
Information on service corresponding to ExemptService: For example, information indicating whether or not IMS Voice service, IMS Video service, IMS SMS service, and the like are included in the ExemptService.
Information on APN corresponding to ExemptService: For example, a network can configure a service corresponding to the ExemptService to be processed via a specific APN. In this case, APN information to be used by the ExemptService is forwarded to a UE. If the DataOff function is activated, the UE activates an APN connected to the ExemptService only. All other APNs can be blocked. The filter information on the ExemptService provided via the APN or application ID information can be included.

When a network forwards information on the ExemptService to a UE, the network can additionally forward information described in the following to the UE.
When the DataOff function is activated, information on an operation to be performed at the time of generating data by a service corresponding to the ExemptService;
When the DataOff function is activated, information on an operation to be performed at the time of generating data by a service not corresponding to the ExemptService, (e.g., information on an operation of determining whether to delete data); and/or

Information on a PLMN or location at which information on the ExemptService is valid.

Meanwhile, the present invention proposes a method that enables a user to perform additional configuration on DataOff. For example, assume that voice call and an SMS service provided by a communication company to which a user A subscribes are defined as ExemptService and a network node forwards information to a UE of the user A. In this case, the UE of the user A informs the user A that the voice call and the SMS service correspond to the ExemptService via a user interface. In this case, the user A may intend to receive the SMS service only without the voice call. For example, when the user A sleeps at night, the user A may want not to wake up due to a phone call. On the contrary, the user A may want to receive important information via SMS, which is less interrupting the sleeping of the user A, while sleeping and may intend to immediately check the important information via the SMS after the user A wakes up. Or, when the user A watches a movie, the user A may intend to check information via the SMS only while not answering the phone call.

Hence, when a network forwards information on Exempt Service to a UE, the present invention proposes that the UE informs the network of information on whether or not the UE properly receives the information. Additionally, the present invention proposes that the UE forwards information on an Exempt Service actually selected by the UE to the network. For example, in the aforementioned situation, if the network informs the UE that the voice call and the SMS service correspond to the exempt service, the UE asks the network to designate the SMS service as the exempt service only after passing through confirmation of a user. If the network finally confirms the request, only the SMS service is designated as the exempt service.

The information on the exempt service designated by the user can also be forwarded to the network when the user activates the DataOff function. The information on the exempt service designated by the user can be configured not only by the exempt service originally proposed by the network but also by a service regarded as an important service by the user. For example, a service rather than a service provided by a communication company may correspond to KakaoTalk. In particular, although the user activates DataOff function, the user may want to receive information related to the KakaoTalk service. In this case, when the user transmits information on ExemptService to the network, the user can transmit the information to the network by adding filter information of a service preferred by the user, an application name, ID information, and the like to the information on the ExemptService.

The information on the ExemptService selected by the user is stored in appropriate nodes such as an MME, an HSS, an S-GW/P-GW, an S-CSCF/I-CSCF/P-CSCF, and the like. The nodes update filter information, service list information, and APN information in accordance with the information on the ExemptService selected by the user, store the updated information in the UE or the network node, and operate according to the description described in many parts of the present invention.

Or, if the UE receives the information on the ExemptService from the network, the UE stores the information in a memory of the UE or a storing area. Subsequently, if a user actually activates the DataOff function, the UE collects information on a service practically selected by the user from among a list of services corresponding to the ExempService information indicated by the network and configures information such as UserSelectedExemptservice. When the UE informs the network that the DataOff function is activated, the UE forwards the UserSelectedExemptservice information to the network together. Subsequently, the network performs the operation mentioned earlier in a different part of the present invention based on the UserSelectedExemptservice information instead of the ExemptService information configured by the network.

Besides the ExemptService indicated by the network, a user may add a service, an application, and the like randomly selected by the user to the UserSelectedExemptservice information. Or, although the network does not transmit the information on the ExemptService to the UE, UserSelectedExemptservice information is randomly configured according to the preference of the user and the randomly configured UserSelectedExemptservice information is forwarded to the network. For example, the UserSelectedExemptservice information can be forwarded to the network when the DataOff function is activated. In this case, the UE additionally includes information capable of representing the service or the application additionally included in the UserSelectedExemptservice information according to the preference of the user. The additional information includes a name of an application, an ID, or filter information capable of classifying a packet.

It may be able to set information indicating an operation to be preferentially performed among CS voice and IMS voice and information indicating CS voice only or IMS voice only to a UE via such a parameter as ‘UE mode of operation’. When a UE is configured to use CS voice only or is configured to preferentially perform CS voice, if the UE activates the DataOff function, the UE consistently performs access through E-UTRAN/EPC. In this case, if actual voice call occurs, the UE should move to 2G or 3G network and delay occurs while moving to the 2G or 3G network. Hence, the present invention proposes the following

If a UE activates Data Off function and there is a service configured to be preferentially used in a CS network among Data Off Exempt Services set to the UE:

the UE moves to 2G or 3G network;

the UE moves to RAT that provides CS network service; or

the UE performs detach in a currently accessed 4G network. Subsequently, the UE performs attach procedure in 2G or 3G network.

In the abovementioned procedure, the UE can perform the abovementioned operation(s) only when all services corresponding to Data Off ExemptServices are configured to preferentially use the CS network.

If the network receives a message including information indicating that Data Off function is activated from the UE, the network forwards information indicating a network in which each of Dataoff Exemptservices set to the UE is to be preferentially used among a CS network, a currently accessed network, and a 4G network to the UE.

If the network receives a message including information indicating that DataOff function is activated from the UE, the network forwards information indicating a network in which detach is to be performed among a CS network, a currently accessed network, and a 4G network to the UE.

In the abovementioned procedure, the UE may operate according to a message received from the network.

Instead of the information indicating whether or not the CS network is to be preferentially used, the network may forward information indicating a domain in which each of DataOff Exemptservices is to be preferentially used among CS domain, IMS domain, and PS domain to the UE. The UE may operate according to the information.

When a UE performs an ATTACH Request procedure or a TAU Request procedure, the UE receives information indicating whether or not each of DataOff Exemptservices is supported in a region at which the UE is located from a network. In this case, the network can forward information indicating whether or not each of the DataOff ExemptServices is supported via an IMS network, a PS network, or an IP network of the network to the UE. If a user activates the DataOff function, the UE can check whether or not services corresponding to the DataOff ExemptServices are supported in a corresponding region. If one of the services corresponding to the DataOff ExemptServices is not supported in the corresponding region, the UE moves to 2G/3G or a network in which a CS service is provided. Otherwise, the UE may stay at a current cell. If all of the services corresponding to the DataOff ExemptServices are not supported in the corresponding region, the UE moves to 2G/3G or a network in which a CS service is provided. Otherwise, the UE may stay at a current cell. Although a service corresponding to the Dataoff Exemptservice is not supported in a corresponding region, if it is notified that the service is able to be provided using CS Fallback, the UE may consider that the service is supported in the region.

When a UE performs an attach procedure, additionally, when the UE performs a TAU procedure, a network can forward information indicating whether or not a DataOff function is used to the UE. In addition, the network forwards information on DataOff ExemptService and information on an APN to be used for the DataOff ExemptService to the UE. Having received the information on the APN, the UE establishes a PDN connection with the APN. Subsequently, if a user activates the DataOff function, the UE can perform a PDN disconnection procedure on other APNs only except the APN with which the PDN connection is established. In the attach procedure, the network can inform the UE of information on an APN used by services. The UE identifies an APN mapped to DataOff Exemptservice and may additionally establish a PDN connection with the identified APN. When the UE establishes the PDN connection with the APN mapped to the DataOff Exemptservice, if a user activates the Dataoff function, the UE may not release the PDN connection.

If DataOff function is activated in a UE designated as Voice Centric, the UE moves to 2G/3G network, moves to a CS network, or performs an LTE detach procedure irrespective of whether or not there exists DataOff Exemptservice. If the voice centric UE is configured to preferentially perform CS voice or is configured to use CS voice only, the voice centric UE can move to 2G, 3G, or a CS network. If DataOff function is activated in a UE designated as Data Centric, the UE moves to 2G/3G network, moves to a CS network, or performs an LTE detach procedure irrespective of whether or not there exists DataOff Exemptservice.

If a UE accesses a CS network or moves to 2G/3G RAT, the UE may not use a DataOff-related operation or configuration. Or, the UE may operate like there is no such a configuration. In particular, the UE may operate under the assumption that a list of DataOff ExemptServices is empty. If a UE accesses a CS network or prefers a CS domain, the UE does not apply a DataOff ExemptService. For example, the UE may consider that the list of DataOff ExemptServices is empty.

A network can transmit information indicating whether or not each of DataOff ExemptServices is supported in a corresponding cell to a UE. A UE can determines whether or not a DataOff ExemptService set to the UE is supported in a corresponding cell. When a user activates the DataOff function, if a UE does not perform Attach yet, the UE can select a cell supporting all DataOff ExemptServices set to the UE. If the UE finds out a cell satisfying the abovementioned condition, the UE may attempt to perform ATTCH to the network via the cell. If the UE does not perform Attach yet, the UE may select a cell partly supporting DataOff ExemptService set to the UE. If the UE finds out a cell satisfying the abovementioned condition, the UE may attempt to perform ATTCH via the cell. Or, if the UE does not perform Attach yet and the UE finds out a cell not supporting the DataOff ExemptService set to the UE or a cell partly supporting the DataOff ExemptService only, the UE may move to 2G/3G or selects a CS network.

When a UE receives configuration information on Dataoff from a Home PLMN of the UE, if the UE camps on a visited PLMN or is in a roaming situation, the UE can receive information on whether or not a cell at which the UE stays supports Dataoff. In this case, if the cell does not support the dataoff and a user activates the dataoff, the UE operates under the assumption that a list of DataOff ExemptServices is empty when the UE accesses the cell.

In the following, a method of providing DataOff-related information or activation (deactivation) information of DataOff function to an IMS network is explained. Following descriptions can be used together with the aforementioned description. A part collided with the aforementioned description can be applied to the following description only.

According to one embodiment of the present invention, an IMS network can obtain information on whether or not a DataOff function is activated or deactivated by a UE. To this end, the UE can transmit an SIP (Session Initiation Protocol) register message including activation information of the DataOff function to an IMS (IP Multimedia Sybsystem) node. In this case, if the DataOff function is activated, the UE can receive an SIP message (SIP service) corresponding to DataOff Exempt Services only from the IMS node. If the DataOff function is not activated, the UE can receive the SIP message irrespective of the DataOff Exempt services. A specific operation related to this shall be described later. The UE can receive a response message (e.g., 200 OK message) in response to the SIP register message. Explanation on a signal transmission/reception procedure related to SIP register between the UE and the IMS node is replaced with the explanation on FIG. 8.

As mentioned in the foregoing description, an IMS network can check whether or not a DataOff function is activated not only via an IMS register procedure (SIP register message) of a UE bot also via a newly defined procedure (e.g., message such as SIP OPTIONS, SIP UPDATE, etc.). The IMS network can also obtain the information on whether or not the DataOff function is activated from a network node rather than the UE. In this case, the network node can include an IMS node, an HSS, a PCRF, and the like. The IMS network may correspond to an S-CSCF and/or an application server(s), by which the present invention may be non-limited. In particular, the IMS network may correspond to various IMS nodes. The application server (AS) may correspond to an AS defined to support the DataOff function. Or, a legacy AS may additionally support the DataOff function (e.g., Telephony AS). In particular, the IMS node may correspond to an S-CSCF (Serving Call State Control Function). The information on whether or not the DataOff function is activated can be transmitted to the S-CSCF via the SIP register message.

If the information indicating whether or not the DataOff function is activated is transmitted using the SIP register message, it may have technical advantages described in the following.

First of all, it is able to solve a problem of a time interval between timing to which data off is applied and data off transmission. If the information on the activation of the DataOff function of the UE is transmitted to an IMS network after a register procedure is performed, a time interval between the timing at which the registration is completed and the timing at which the activation information of the DataOff function is received occurs. If an MT (Mobile terminated) SIP request requested to the UE occurs during the time interval, the S-CSCF forwards the SIP request to the UE. In particular, although the DataOff function is activated, the UE receives the MT SIP request. In particular, if the SIP request forwarded to the UE is not DataOff ExemptServices, it may lead to a result that the reliability of a network of a user or a UE is deteriorated.

Second, similar to the first case, it may be able to prevent unnecessary consumption of a network resource. In order to indicate whether or not a DataOff function of a UE is activated to an IMS network via a non-IMS/SIP message rather than an IMS register message, it is necessary to exchange signaling between network nodes in EPC and IMS network. In particular, when a UE informs a network of information on whether or not DataOff is activated via a NAS message, if an MME receives the NAS message, it is necessary for the MME (no interface to IMS network) to forward the message to a network node including an interface (e.g., HSS including IMS network and interface) via an IMS network. Subsequently, it is necessary for the HSS to forward the information on whether or not the DataOff function of the UE is activated to the S-CSCF. In particular, if an IMS/SIP message is not used, the information on whether or not the DataOff function of the UE is activated is forwarded to the IMS network via a control plane by passing through a plurality of networks, it leads to the consumption of network resources.

Third, if information on whether or not DataOff function is activated is transmitted via an IMS register message, an AS (application server) related to DataOff is able to identify whether or not the DataOff function is activated according to a legacy 3^{rd} party registration procedure without a separate additional procedure.

Fourth, if information on whether or not DataOff function is activated is transmitted via an IMS register message, it is able to solve the necessity for mapping an IP address, which is notified to an IMS network to receive an IMS service, with the information on whether or not DataOff function is activated.

Subsequently, whether or not an SIP message corresponds to DataOff Exempt Services can be determined by filter criteria obtained from an HSS (Hoe Subscriber Server).

If an S-CSCF receives an SIP message (or SIP request), matching is performed by evaluating a service point trigger (SPT). In particular, if the message is matched with criteria, a relevant operation is performed. If a user activates the DataOff function, an operation is performed based on matching criteria in response to the activated DataOff function. Hence, the SIP message can be additionally forwarded to a related AS. The forwarding of the SIP message forwarded to the AS can be performed when the SIP message corresponds to a permitted service, not permitted service, or both depending on the configuration of the IFC.

IFC (Initial Filter Criteria) is configured to include information on DataOff Exempt Services. To this end, the IFC can be configured to include information on a service which is permitted when a user activates the DataOff function. On the contrary, the IFC can be configured to include information on a service which is not permitted when a user activates the DataOff function. Or, the IFC can be configured to include both of the services.

If the configuration of the IFC includes information on an AS, the AS can include a service logic to be performed on DataOff Exempt Services (permitted services) and/or not permitted services when the DataOff function is activated. The IFC can also be interpreted as Filter Criteria. The Filter Criteria correspond to information obtained by the S-CSCF from the HSS as a sort of subscriber information (i.e., user profile or user data). Hence, information on DataOff Exempt Services can be obtained from the HSS as a sort of subscriber information.

An S-CSCF configured to serve a UE obtains subscriber information from the HSS when the UE registers at an IMS. This is performed in the step S807 among TS 23.228 IMS Registration Procedures mentioned earlier in FIG. 8. A message of the step S807 is described in TS 29.229 section 6.1.4 (Server-Assignment-Answer (SAA) Command) In a message format shown in Table 2 in the following, User-Data corresponds to the subscriber information.

TABLE 2
Message Format<Server-Assignment-Answer> ::=< Diameter Header:
301, PXY, 16777216 >< Session-Id >[ DRMP ]{ Vendor-Specific-
Application-Id } [ Result-Code ][ Experimental-Result ]
{ Auth-Session-State }{ Origin-Host }{ Origin-Realm }
[ User-Name ][ OC-Supported-Features ][ OC-OLR ]*[
Supported-Features ][ User-Data ][ Charging-Information ]
[ Associated-Identities ][ Loose-Route-Indication ]*[ SCSCF-
Restoration-Info ][ Associated-Registered-Identities ][ Server-
Name ] [ Wildcarded-Public-Identity ] [ Priviledged-Sender-
Indication ] [ Allowed-WAF-WWSF-Identities ]*[ AVP ]*[
Failed-AVP ]*[ Proxy-Info ]*[ Route-Record ]

The User-Data corresponds to a user profile defined in TS 29.228.

If the SIP message corresponds to a permitted service, at least one of operations described in the following can be performed.
The C-CSCF processes the SIP message according to a legacy method. For example, if the SIP message corresponds to voice call and the voice call corresponds to DataOff Exempt Services, similar to the legacy method, the voice call (i.e., the SIP message) is forwarded to a user.
The AS processes the SIP message based on service logic. For example, if the SIP message corresponds to voice call and the voice call corresponds to DataOff Exempt Services, the AP can indicate an S-CSCF to forward the voice call (i.e., the SIP message) to a user.

Consequently, since the SIP message corresponds to a permitted service, an object is to provide the service to a user irrespective of whether or not the DataOff function is activated.

If the SIP message corresponds to a not permitted service, at least one of operations described in the following can be performed.
The S-CSCF determines not to forward the SIP message to a user. For example, if the SIP message corresponds to video call and the video call does not correspond to DataOff Exempt Services, the S-CSCF determines not to forward the video call (i.e., the SIP message) to a user. In addition, the S-CSCF can generate a response message such as a reject, undeliverable, or an error and transmit the response message to a user/IMS network, which has generated the SIP message, in response to the SIP message.
The AS processes the SIP message based on service logic. For example, if the SIP message corresponds to video call and the video call does not correspond to DataOff Exempt Services, the AP can indicate an S-CSCF not to forward the video call (i.e., the SIP message) to a user. In addition, the AS can generate a response message such as a reject, undeliverable, or an error and transmit the response message to the S-CSCF in response to the SIP message.

Consequently, since the SIP message corresponds to a not permitted service, an object is not to provide the service to a user who has activated the DataOff function.

In the following, various methods for forwarding a signal related to DataOff function to a network are explained.

First of all, a UE is able to inform a network of activation or deactivation of a DataOff function. Activation information of the DataOff function can also be transmitted at the time of requesting a PDN (Packet Data Network) connection. In this case, the activation information of the DataOff function can be included in PCO (Protocol Configuration Options). In particular, when a UE asks a network to establish the PDN connection, the UE may include information indicating that the DataOff function is activated in the PDN connection establishment request. Although DataOff function is activated, it is necessary to establish a PDN (APN) to provide DataOff Exempt Services. The above operation can be performed at the time of performing an attach procedure or the time of performing a separate PDN connection establishment request procedure. If a UE activates the DataOff function in a state that a PDN connection is already established and it is necessary not to disconnect (i.e., maintain) the PDN to provide DataOff Exempt Services, the UE may inform a network of information indicating that the DataOff function is activated while maintaining the PDN. Or, the UE may disconnect the PDN connection and inform the network of information indicating that the DataOff function is activated while asking the network to establish the PDN connection again. A legacy procedure (e.g., UE requested bearer resource modification, etc.) or a newly defined procedure can be used for the former case. If a UE activates the DataOff function and then deactivates the DataOff function, the UE can inform a network of information indicating that the DataOff function is deactivated while maintaining a PDN, which is maintained to provide DataOff Exempt Services. Or, the UE may disconnect the PDN connection and inform the network of information indicating that the DataOff function is deactivated while asking the network to establish the PDN connection again. A legacy procedure (e.g., UE requested bearer resource modification, etc.) or a newly defined procedure can be used for the former case.

The information indicating the activation or deactivation of the DataOff function can be explicitly or implicitly included in a NAS message, which is transmitted to the network by the UE, in various forms. For example, the information may correspond to APN, indication, flag, parameter, or the like. And, the information indicating the activation or deactivation of the DataOff function can be included in PCO (Protocol Configuration Options). The PCO correspond to a parameter included in such a session management NAS message as a PDN connectivity request, a bearer resource modification request message. If a UE includes the PCO, the PCO is forwarded up to a P=GW after passing through an MME and an S-GW.

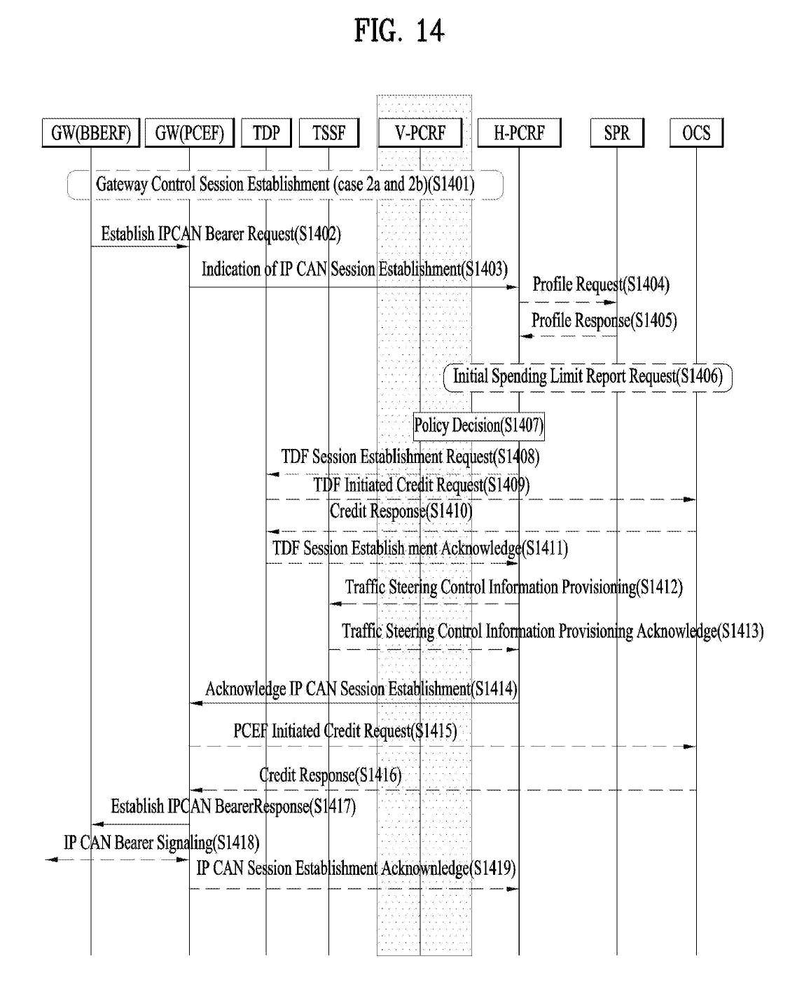

Second, when IP-CAN Session is established, DataOff function-related information can be provided/set to a traffic steering control-related network node. In this case, traffic steering means that an appropriate service function is adjusted. Explanation on the traffic steering is replaced with the contents described in 3GPP TS 23.303. FIG. 14 is a flowchart for an IP-CAN session establishment procedure according to one embodiment of the present invention. In the step S1408, if traffic steering control is applied via Sd interface (or TDF: Traffic Detection Function), a PCRF provides DataOff function-related information to a TDF. In the step S1412, if traffic steering control is applied via St interface (or TSSF: Traffic Steering Support Function), a PCRF provides DataOff function-related information to a TSSF. In the step S1414, if traffic steering control is applied via Gx interface (or PCEF: Policy and Charging Enforcement Function), a PCRF provides DataOff function-related information to a PCEF (i.e., P-GW). For detail explanation on each step, it may refer to 3GPP TS 23.203 section 7.2.

In the foregoing description, the DataOff function-related information can include one or more information among information described in the following. The PCRF can obtain the information from subscriber information and/or a UE and/or a different network node. The PCRF can provide the information as a part of ADC (Application Detection and Control) Rules or provide the information as separate information.
DataOff Exempt Services-related traffic steering information (or DataOff Exempt Services-related information): can include information on a permitted service and/or information on a not permitted service when a UE activates the DataOff function.
Information indicating whether or not the DataOff function is activated
Information indicating whether or not the DataOff function is deactivated

The DataOff Exempt Services-related traffic steering information can be set to a traffic steering control-related network node (PCEF, TDF, or TSSF) in advance without being received from the PCRF.

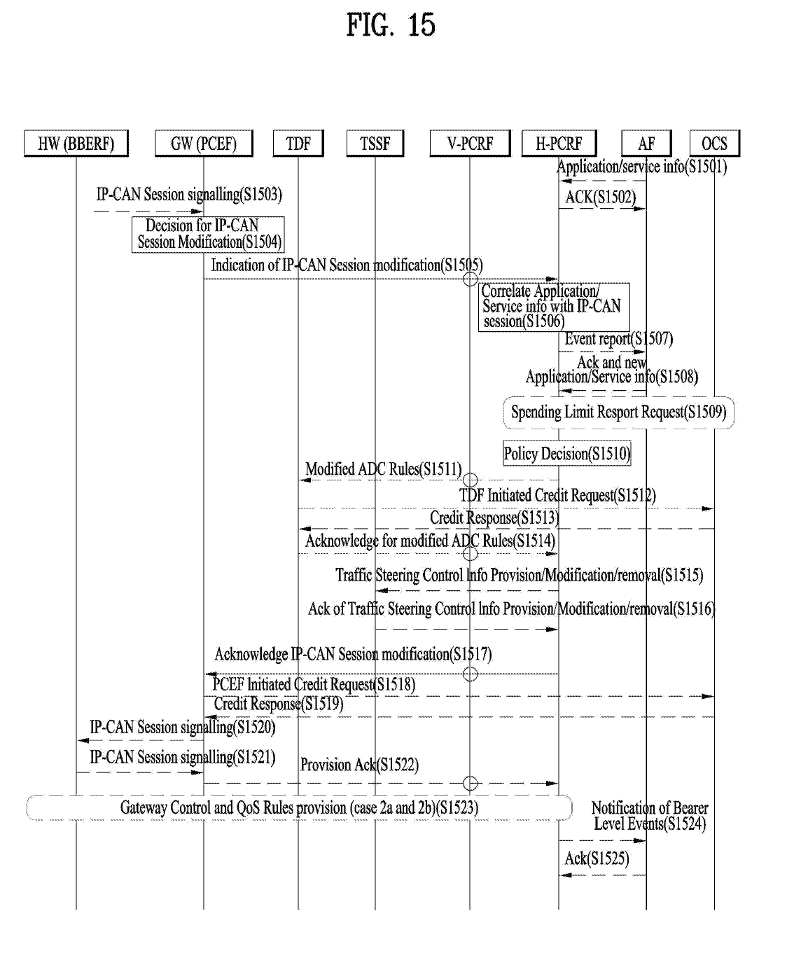

Third, when IP-CAN Session is modified, DataOff function-related information can be provided/set to a traffic steering control-related network node. In relation to this, referring to FIG. 15, in the step S1511, if traffic steering control is applied via Sd interface (or TDF: Traffic Detection Function), a PCRF provides DataOff function-related information to a TDF. In the step S1515, if traffic steering control is applied via St interface (or TSSF: Traffic Steering Support Function), a PCRF provides DataOff function-related information to a TSSF. In the step S1517, if traffic steering control is applied via Gx interface (or PCEF: Policy and Charging Enforcement Function), a PCRF provides DataOff function-related information to a PCEF (i.e., P-GW). For detail explanation on each step, it may refer to 3GPP TS 23.203 section 7.4. In particular, an IP-CAN Session Modification procedure shown in FIG. 15 can be mainly performed when a UE changes the DataOff function from deactivation to activation or changes the DataOff function from activation to deactivation, by which the present invention may be non-limited.

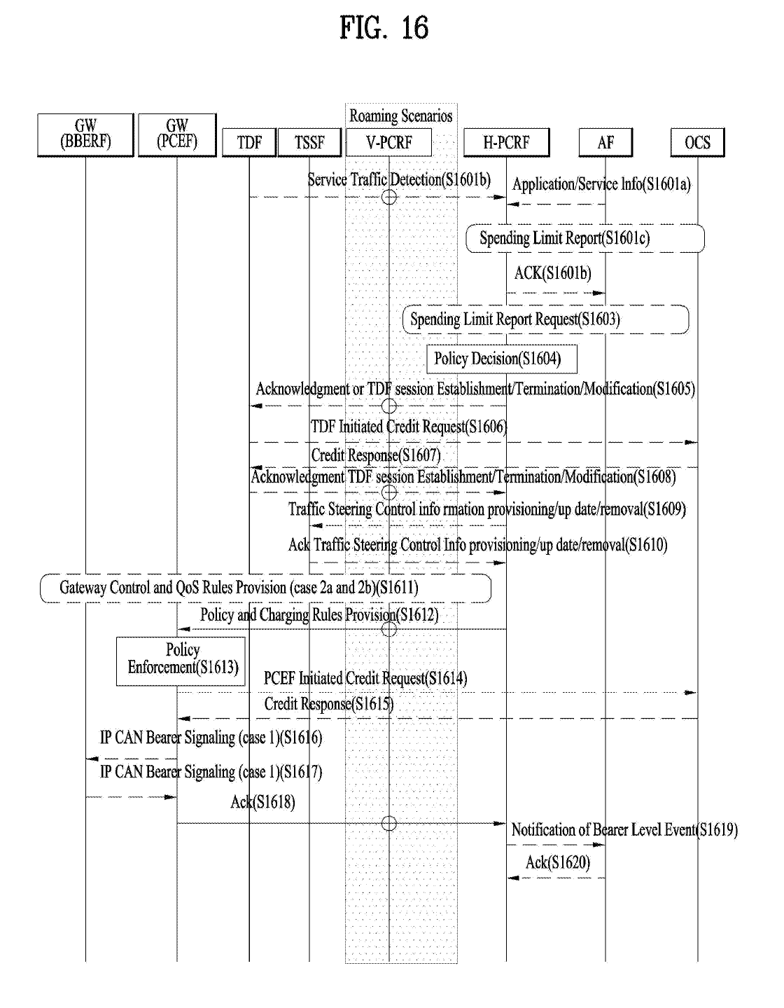

FIG. 16 is a flowchart for an IP-CAN session modification procedure initiated by a PCRF according to one embodiment of the present invention. Referring to FIG. 16, in the step S1605, if traffic steering control is applied via Sd interface (or TDF: Traffic Detection Function), a PCRF provides DataOff function-related information to a TDF. In the step S1609, if traffic steering control is applied via St interface (or TSSF: Traffic Steering Support Function), a PCRF provides DataOff function-related information to a TSSF. In the step S1612, if traffic steering control is applied via Gx interface (or PCEF: Policy and Charging Enforcement Function), a PCRF provides DataOff function-related information to a PCEF (i.e., P-GW).

For the DataOff function-related information mentioned earlier in FIGS. 15 and 16, it may refer to the contents mentioned earlier in the IP-CAN Session Establishment. In particular, an IP-CAN Session Modification procedure shown in FIG. 16 can be mainly performed when a UE intends to establish a new IMS session (or SIP session), a request for establishing a new IMS session occurs at a UE, an IMS terminating call occurs at the UE, or an IMS session of the UE is changed, by which the present invention may be non-limited.

As mentioned in the foregoing description, when DataOff-related information is forwarded to a network, downlink traffic transmitted to UE can be processed as follows.

If a network node performing traffic steering control (or a node receiving DataOff function-related information from a PCRF) receives downlink traffic heading towards the UE, the network node performs a traffic steering operation based on the DataOff function-related information. This operation may include an operation of forwarding the received traffic to an enabler (or Value Added Service (VAS) or Service Function (SF)) supporting the DataOff function located at SGi-LAN. The forwarding of the received traffic forwarded to the enabler can be performed only when the DataOff function is activated, only when the DataOff function is deactivated, or can be performed for both cases based on the DataOff function-related information. In addition, when the DataOff function is activated, the forwarding can be performed only when the received traffic corresponds to DataOff Exempt Services, only when the received traffic do not correspond to the DataOff Exempt Services, or can be performed for both cases (irrespective of a service) based on the DataOff function-related information.

When the DataOff function is activated, the enabler recognizes traffic (e.g., SIP message or data traffic) corresponding to a not permitted service and can perform a function of eliminating the traffic. Or, when the DataOff function is activated, the enabler recognizes traffic (e.g., SIP message or data traffic) corresponding to a permitted service and can perform a function of continuously routing the traffic. In addition, a network node performing traffic steering control may perform marking on traffic in relation to the DataOff function before the received traffic is forwarded to the enabler. The marking may correspond to information indicating a permitted service or a not permitted service when the DataOff function is activated.

In order for a traffic steering control-related network node (PCEF, TDF, TSSF) and the enabler to recognize traffic corresponding to a permitted/not permitted service, it may be able to utilize one or more information among information described in the following, by which the present invention may be non-limited. It may be able to utilize various informations of various layers to determine whether traffic corresponds to a permitted service or a not permitted service.

i) If traffic corresponds to an SIP message,
Type of SIP method (e.g., INVITE, MESSAGE, REFER, etc.)
Source IP address of originating UE of SIP message
Port # of originating UE of SIP message
Source IP address of destination UE of SIP message
Port # of destination UE of SIP message
SDP information of SIP message (e.g., media type)
Various header/tag/parameter information of SIP message

ii) If traffic does not correspond to SIP message (or data traffic)
Source IP address of originating UE
Port # of originating UE
Source IP address of destination UE
Port # of destination UE
IP header information and/or transport layer header information

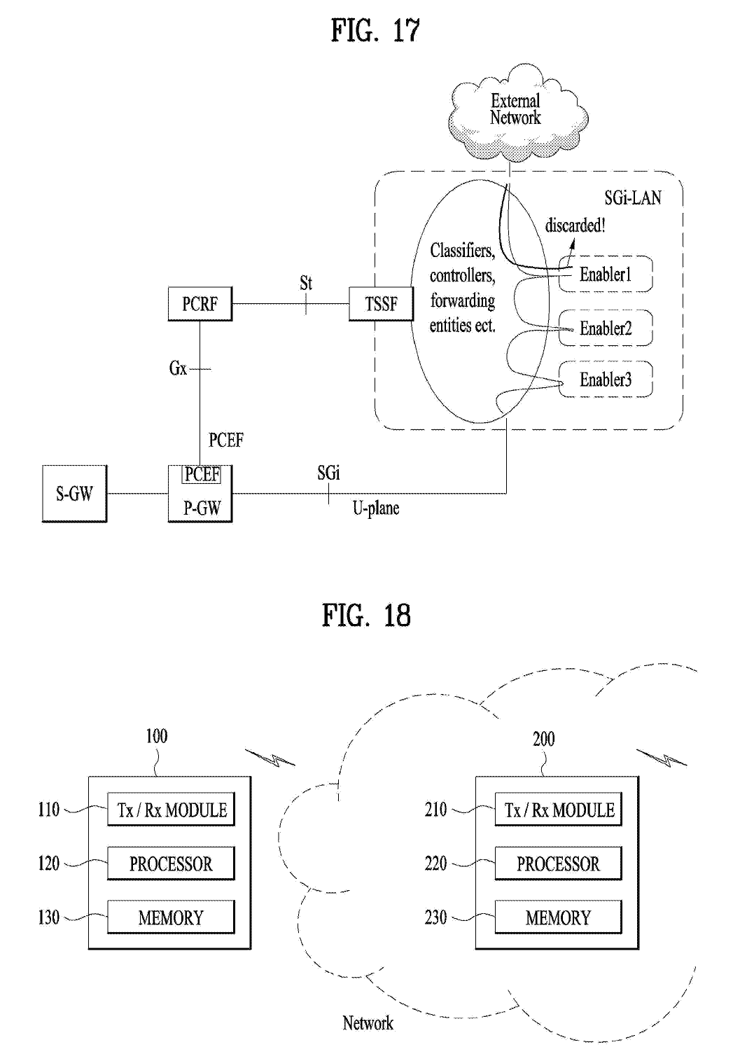

FIG. 17 illustrates an example of traffic steering according to the present invention. In FIG. 17, assume that an enabler 1 corresponds to an enabler that supports the DataOff function and a TSSF performs traffic steering control. If downlink traffic heading towards to a UE, which has activated the DataOff function, is received, the TSSF forwards the received traffic to the enabler 1 (by recognizing the activated DataOff function) based on configured DataOff function-related information. If the traffic corresponds to DataOff Exempt Services, the enabler 1 continuously performs routing to make the traffic to be forwarded to the UE. Otherwise, the enabler 1 deletes the traffic. Or, if downlink traffic heading towards to a UE, which has activated the DataOff function, is received, the TSSF forwards the received traffic to the enabler 1 (by recognizing that the DataOff function is activated and the traffic corresponds to a not permitted service) based on configured DataOff function-related information. The enabler 1 deletes the traffic.

In the foregoing description, the UE may correspond to a UE supporting PS (packet switch) only or a UE which has accessed a network supporting PS only. In particular, the UE may correspond to a UE considerably requiring the technology related to the DataOff. As mentioned in the foregoing description, a user blocks an internet connection function using a mobile data switch or the like. This is because, if a UE/network support PS only, it is unable to use voice call, emergency message, and the like delivered via the PS as well. And, the UE may correspond to a user in a roaming state. Many users intend to block the internet connection function using the mobile data switch in the roaming state. The user in the roaming state may also correspond to a UE considerably requiring the technology related to the DataOff. The description on the present invention can be applied not only to the UE of the abovementioned condition but also to a UE/network supporting both a CS and a PS and a UE in a roaming/non-roaming state.

FIG. 18 is a diagram for a configuration of a node device applied to the proposal of the present invention.

A user equipment (UE) 100 may include a transceiver 110, a processor 120, and a memory 130. The transceiver 110 can also be referred to as an RF (radio frequency) unit. The transceiver 110 may be configured to transmit and receive various signals, data, and information to/from an external device. Alternatively, the transceiver 110 may be implemented with a combination of a transmitter and a receiver. The UE 100 may be connected to the external device by wire and/or wirelessly. The processor 120 may be configured to control overall operations of the UE 100 and process information to be transmitted and received between the UE 100 and the external device. Moreover, the processor 120 may be configured to perform the UE operation proposed in the present invention. The memory 130, which may be replaced with an element such as a buffer (not shown in the drawing), may store the processed information for a predetermined time.

Referring to FIG. 18, a network node 200 according to the present invention may include a transceiver 210, a processor 220, and a memory 230. The transceiver 210 can also be referred to as an RF (radio frequency) unit. The transceiver 210 may be configured to transmit and receive various signals, data, and information to/from an external device. The network node 200 may be connected to the external device by wire and/or wirelessly. The processor 220 may be configured to control overall operations of the network node 200 and process information to be transmitted and received between the network node device 200 and the external device. Moreover, the processor 220 may be configured to perform the network node operation proposed in the present invention. The memory 230, which may be replaced with an element such as a buffer (not shown in the drawing), may store the processed information for a predetermined time.

The specific configurations of the UE 100 and the network node 200 may be implemented such that the aforementioned various embodiments of the present invention can be independently applied or two or more embodiments can be simultaneously applied. For clarity, redundant description will be omitted.

The embodiments of the present invention may be implemented using various means. For instance, the embodiments of the present invention may be implemented using hardware, firmware, software and/or any combinations thereof.

In case of the implementation by hardware, a method according to each embodiment of the present invention may be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code may be stored in a memory unit and be then executed by a processor. The memory unit may be provided within or outside the processor to exchange data with the processor through the various means known to the public.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Therefore, the present invention is non-limited by the embodiments disclosed herein but intends to give a broadest scope matching the principles and new features disclosed herein.

### INDUSTRIAL APPLICABILITY

Although the aforementioned communication method are described centering on examples applied to 3GPP system, it may also be applicable to various wireless communication systems including IEEE 802.16x and 802.11x system. Moreover, the proposed method can also be applied to mmWave communication system using a microwave frequency band.

What is claimed is:

1. A method of transmitting and receiving a signal related to a DataOff function of a UE (user equipment) in a wireless communication system, comprising the steps of:
transmitting an SIP (Session Initiation Protocol) register message containing activation information of the DataOff function to an IMS (IP Multimedia Subsystem) node, wherein if the DataOff function is activated, the UE receives only an SIP message corresponding to DataOff Exempt Services from the IMS node; and
receiving a response message in response to the SIP register message.

2. The method of claim 1, wherein the IMS node corresponds to an S-CSCF (Serving Call State Control Function).

3. The method of claim 1, wherein the activation information of the DataOff function is transmitted even when a PDN (Packet Data Network) connection is requested.

4. The method of claim 3, wherein the activation information of the DataOff function is contained in PCO (Protocol Configuration Options).

5. The method of claim 1, wherein whether or not the SIP message corresponds to the DataOff Exempt Services is determined by Filter Criteria obtained from an HSS (Home Subscriber Server).

6. The method of claim 1, wherein if the DataOff function is not activated, the UE receives the SIP message irrespective of the Data Exempt Services.

7. The method of claim 1, wherein the UE corresponds to a UE supporting PS (Packet Switch) only or a UE which has accessed a network supporting the PS only.

8. The method of claim 7, wherein the UE corresponds to a user in a roaming state.

9. A UE (user equipment) transmitting and receiving a signal related to a DataOff function in a wireless communication system, comprising:
a transceiver; and
a processor, the processor configured to transmit an SIP register message containing activation information of the DataOff function to an IMS node, wherein if the DataOff function is activated, the UE receives only an SIP message corresponding to DataOff Exempt Services from the IMS node, the processor configured to receive a response message in response to the SIP register message.

10. The UE of claim 9, wherein the IMS node corresponds to an S-CSCF (Serving Call State Control Function).

11. The UE of claim 9, wherein the activation information of the DataOff function is transmitted even when a PDN (Packet Data Network) connection is requested.

12. The UE of claim 11, wherein the activation information of the DataOff function is contained in PCO (Protocol Configuration Options).

13. The UE of claim 9, wherein whether or not the SIP message corresponds to the DataOff Exempt Services is determined by Filter Criteria obtained from an HSS (Home Subscriber Server).

14. The UE of claim 9, wherein if the DataOff function is not activated, the UE receives the SIP message irrespective of the Data Exempt Services.

15. The UE of claim 9, wherein the UE corresponds to a UE supporting PS (Packet Switch) only or a UE which has accessed a network supporting the PS only.
